(19) United States
(12) Patent Application Publication
(10) Pub. No.: US 2025/0226671 A1
(43) Pub. Date: Jul. 10, 2025

(54) HYBRID ENERGY STORAGE PLANT DESIGN WITH INTEGRATED CONTROL FOR CLEAN FIRM RENEWABLE POWER

(71) Applicant: AES Clean Energy Services, LLC, Salt Lake City, UT (US)

(72) Inventor: Charles Reynolds, Fort Collins, CO (US)

(73) Assignee: AES Clean Energy Services, LLC, Salt Lake City, UT (US)

(21) Appl. No.: 19/011,237

(22) Filed: Jan. 6, 2025

Related U.S. Application Data
(60) Provisional application No. 63/617,937, filed on Jan. 5, 2024.

(51) Int. Cl. H02J 3/46; C25B 9/65; C25B 15/02; H02J 3/00; H02J 3/32

(52) U.S. Cl. CPC H02J 3/46; C25B 9/65; C25B 15/02; H02J 3/004; H02J 3/32; H02J 2300/24; H02J 2300/28

(57) ABSTRACT

A method and system for integrated control of a first renewable energy system, a second renewable energy system, and a load system to implement a hybrid plant system. A first renewable energy system is configured to generate a first source of energy and to store at least a part of the energy generated by the first source of energy. A second renewable energy system is configured to generate a second source of energy and to store at least a part of the energy generated by the second source of energy. At least one controller is configured to receive a respective status for the first renewable energy system, the second renewable energy system, and the one or more loads and determine and perform common control of at least two of: the first renewable energy system; the second renewable energy system; and the one or more loads.

### REFERENCE TO RELATED APPLICATION

This application claims priority to U.S. Provisional Application Ser. No. 63/617,937 filed Jan. 5, 2024, the entire disclosure of which is hereby incorporated by reference herein.

### FIELD OF THE INVENTION

The present application relates generally to the field of renewable energy, more specifically to the control and integration of multiple renewable energy resources, including any combination of one or more renewable energy systems to generate and store a source of energy, one or more loads, and at least one controller to implement a hybrid plant system.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Renewable energy may be produced from sources such as the sun and wind that are naturally replenished and may be used for a variety of purposes, including electricity generation, space and water heating and cooling, and transportation.

### SUMMARY

In one or some embodiments, a hybrid plant system is disclosed. The hybrid plant system includes: a first renewable energy system configured to generate a first source of energy and to store at least a part of the energy generated by the first source of energy; a second renewable energy system configured to generate a second source of energy and to store at least a part of the energy generated by the second source of energy, wherein the second source of energy is of a different type than the first source of energy; and at least one controller in communication with the first renewable energy system, the second renewable energy system, and one or more loads. The at least one controller configured to: receive a respective status for the first renewable energy system, the second renewable energy system, and the one or more loads, wherein the respective status of the first renewable energy system is indicative of stored energy or forecasted generated energy of the first renewable energy system, wherein the respective status of the second renewable energy system is indicative of the stored energy or the forecasted generated energy of the second renewable energy system, and wherein the respective status of the one or more loads is indicative of operation of the one or more loads; determine common control of at least two of: (i) the first renewable energy system; (ii) the second renewable energy system; and (iii) the one or more loads; and perform the common control of the at least two of: (i) the first renewable energy system; (ii) the second renewable energy system; and (iii) the one or more loads.

In one or some embodiments, a method for managing a hybrid plant system is disclosed. The method includes: generating, by a first renewable energy system, a first source of energy; storing, by the first renewable energy system, at least a part of the energy generated by the first source of energy; generating, by a second renewable energy system, a second source of energy; storing, by the second renewable energy system, at least a part of the energy generated by the second source of energy, wherein the second source of energy is of a different type than the first source of energy; receiving, by at least one controller in communication with the first renewable energy system, the second renewable energy system, and one or more loads, a respective status for the first renewable energy system, the second renewable energy system, and the one or more loads, wherein the respective status of the first renewable energy system is indicative of stored energy or forecasted generated energy of the first renewable energy system, wherein the respective status of the second renewable energy system is indicative of the stored energy or the forecasted generated energy of the second renewable energy system, and wherein the respective status of the one or more loads is indicative of operation of the one or more loads; determining, by the at least one controller, common control of at least two of: (i) the first renewable energy system; (ii) the second renewable energy system; and (iii) the one or more loads; and performing, by the at least one controller, the common control of the at least two of: (i) the first renewable energy system; (ii) the second renewable energy system; and (iii) the one or more loads.

In one or some embodiments, a hybrid plant system is disclosed. The hybrid plant system includes: a photovoltaic (PV) system configured to directly convert solar irradiation to generate a first source of energy; a battery system configured to store at least a part of the first source of energy; a concentrated solar power (CSP) system configured to concentrate solar energy to generate a second source of energy; a long-duration energy storage (LDES) system configured to store at least a part of the second source of energy; and at least one controller in communication with the PV system, the battery system, the LDES system and the CSP system. The at least one controller is configured to: receive a respective status from one or more of the PV system, the battery system, the LDES system or the CSP system; determine control of one or more of: the PV system or the battery system; LDES system or the CSP system in order to modify operation of one or more remaining of: the PV system or the battery system; or the LDES system or the CSP system based on the received status; and perform the control of one or more of: the PV system or the battery system; or the LDES system or the CSP system.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIGS. 1A-B depict block diagrams of a first example of the hybrid plant system.

FIGS. 2A-D depict block diagrams of a second example of the hybrid plant system.

FIG. 3 depicts a block diagram of yet another hybrid plant system.

FIG. 4 depicts a block diagram of still another hybrid plant system.

FIG. 5 depicts a block diagram of another hybrid plant system.

FIG. 6 depicts a block diagram of another hybrid plant system.

FIG. 7 depicts a block diagram of another hybrid plant system.

FIG. 8 depicts a block diagram of another hybrid plant system.

FIG. 9 depicts a block diagram of another hybrid plant system.

FIG. 10 depicts a flow diagram for controlling a hybrid plant system.

FIG. 11 depicts another flow diagram for controlling a hybrid plant system.

FIG. 12 depicts another flow diagram for controlling a hybrid plant system.

FIG. 13 is a diagram of a computer system that may be utilized to implement the system and methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

When a component, device, element, or the like of the present disclosure is described as having a purpose or performing an operation, function, or the like, the component, device, or element should be considered herein as being “configured to” meet that purpose or to perform that operation or function.

Renewable energy sources, such as biomass, geothermal resources, sunlight, water, and wind, are natural resources that may be converted into several types of clean, usable energy such as bioenergy, geothermal energy, hydrogen, hydropower, marine energy, solar energy, wind energy, and the like. As one example, photovoltaics (PVs), such as solar panels, is one type of renewable energy system that converts sunlight into solar energy. As another example, wind turbines are another type of renewable energy system that converts wind into wind energy. As still another example, a concentrated solar power system (CSP) (alternatively termed a concentrating solar power system or a concentrated solar thermal system) may generate solar power using mirrors or lenses to concentrate a large area of sunlight into a receiver.

Typically, each renewable energy system has benefits and drawbacks. As one example, a PV system is dependent on the amount of sunlight on any given day and cannot generate solar energy after sundown. As such, the amount of solar energy may vary significantly, both from day-to-day, and from day to night. The PV system, when paired with a battery system (e.g., battery energy storage system (BESS)), interchangeably termed a PV/BESS system, may essentially smooth out the varying amount of solar energy generated by the PVs by storing excess solar energy in the batteries for use during various times, whether during the day or at night. As another example, a wind farm is dependent on the amount of wind at any given time. Again, the amount of wind energy may vary significantly.

Typically, a renewable energy system is managed, controlled or operated in a siloed manner. As one example, the PVs and the BESS in the PV/BESS system are managed in combination, with the BESS being used to compensate for variances in the amount of solar energy generated by the PVs. As another example, a wind farm will seek to manage its wind turbines, such as by yawing, in order to maximize the amount of wind energy generated.

Because of this siloed approach, renewable energy systems are typically overprovisioned. As one example, the PV/BESS system may be contractually obligated to provide a predetermined amount of power at predetermined time(s) (e.g., 10 MW during a predetermined time period). Because less sunlight is available at various times in a respective day (e.g., due to clouds) or at a respective time of year (e.g., during winter), the PV/BESS system may require additional solar panels and batteries in order to account for less sunlight while still generating at least the predetermined amount of power at the predetermined time(s). As another example, because wind may vary in a respective day and/or respective time of year, the wind farm may require additional wind turbines to generate at least the predetermined amount of power at the predetermined time(s).

In contrast, in one or some embodiments, multiple renewable energy resources are managed, controlled or operated in combination (e.g., at least a first renewable energy resource and a second renewable energy resource managed, controlled or operated in combination; at least a first renewable energy resource, a second renewable energy resource, and a third renewable energy resource managed, controlled or operated in combination; at least a first renewable energy resource, a second renewable energy resource, a third renewable energy resource, and a fourth renewable energy resource managed, controlled or operated in combination; etc.). As merely one example, the additional energy generated by a first renewable energy resource (e.g., based on presumed benefit of the first renewable energy resource) may be routed to a second renewable energy resource (e.g., to mitigate a presumed drawback of the second renewable energy resource), and vice-versa, as discussed in more detail below. As another example, a presumed drawback of the first renewable energy resource may be compensated for by operation of the second renewable energy resource, and vice-versa, as discussed in more detail below. With this integrated management, the benefits of a first renewable energy resource (e.g., excess power from the PV/BESS system) may be better leveraged by combined control with the second renewable energy resource and/or the drawbacks of the first renewable energy resource (e.g., reduction in solar energy during cloudy days or winter months) may be mitigated or reduced by combined control with the second renewable energy resource, as discussed further below.

Likewise, energy storage systems, such as energy storage systems paired with renewable energy resources, are managed, controlled or operated in a siloed manner. As one example, shorter-term battery energy storage systems (BESS), examples of which are lithium-ion battery energy storage systems or sodium-ion battery energy storage systems, are configured to store energy on a shorter-term basis. As another example, longer-term BESS, an example of which is a long-duration energy storage (LDES) system, are configured to store energy on a longer-term basis. As a general matter, at least one shorter-term BESS and at least one longer-term BESS are not paired together. More specifically, when pairing the shorter-term BESS and longer-term BESS, the combination may be managed, controlled and/or operated in an integrated manner. In one such integration, the control of the shorter-term BESS and longer-term BESS may be on any one, any combination, or all of the following basis: timing based; environment based; load based; or amount of power based.

One example of timing-based control is within a respective day, with daytime for routing more power from the shorter-term BESS (e.g., a majority of the power during daytime being routed from the shorter-term BESS (and less than 50% of the power during daytime being routed from the longer-term BESS); at least 60% of the power during daytime being routed from the shorter-term BESS; at least 70% of the power during daytime being routed from the shorter-term BESS; at least 80% of the power during daytime being routed from the shorter-term BESS; at least 90% of the power during daytime being routed from the shorter-term BESS; or exclusively routing power during daytime from the shorter-term BESS) and nighttime for routing more power from the longer-term BESS (e.g., a majority of the power during nighttime being routed from the longer-term BESS (and less than 50% of the power during nighttime being routed from the shorter-term BESS); at least 60% of the power during nighttime being routed from the longer-term BESS; at least 70% of the power during nighttime being routed from the longer-term BESS; at least 80% of the power during nighttime being routed from the longer-term BESS; at least 90% of the power during nighttime being routed from the longer-term BESS; or exclusively routing power during nighttime from the longer-term BESS). In this way, power may be routed to a respective load 24 hours a day and 7 days a week.

Another example of timing-based control is within different seasons. For example, for summertime, the shorter-term BESS may route more power than the longer-term BESS (e.g., a majority of the power during summertime (e.g., for a 24 hour period of a respective day in summertime; for at least a 1 week period in summertime; for at least 1 month period in summertime; for the entire 3 month period of summertime) being routed during summertime from the shorter-term BESS (and less than 50% of the power being routed from the longer-term BESS); at least 60% of the power during summertime being routed from the shorter-term BESS; at least 70% of the power during summertime being routed from the shorter-term BESS; at least 80% of the power during summertime being routed from the shorter-term BESS; or at least 90% of the power during summertime being routed from the shorter-term BESS) and wintertime for routing more power from the longer-term BESS (e.g., a majority of the power during wintertime (e.g., for a 24 hour period of a respective day in wintertime; for at least a 1 week period in wintertime; for at least 1 month period in wintertime; for the entire 3 month period of wintertime) being routed from the longer-term BESS (and less than 50% of the power during wintertime being routed from the shorter-term BESS); at least 60% of the power during wintertime being routed from the longer-term BESS; at least 70% of the power during wintertime being routed from the longer-term BESS; at least 80% of the power during wintertime being routed from the longer-term BESS; or at least 90% of the power during wintertime being routed from the longer-term BESS).

One example of environment-based control is based on weather conditions, such as whether within a respective time period (e.g., for a respective daytime period), are considered sunny (e.g., the amount of sunlight is greater than a first predetermined amount) and/or are considered cloudy (e.g., the amount of sunlight is less than a second predetermined amount that is less than the first predetermined amount). In such an instance, the control system may route more power from the shorter-term BESS during a sunny time (e.g., a majority of the power during the sunny time being routed from the shorter-term BESS (and less than 50% of the power during the sunny time being routed from the longer-term BESS); at least 60% of the power during the sunny time being routed from the shorter-term BESS; at least 70% of the power during the sunny time being routed from the shorter-term BESS; at least 80% of the power during the sunny time being routed from the shorter-term BESS; at least 90% of the power during the sunny time being routed from the shorter-term BESS; or exclusively routing power during the sunny time from the shorter-term BESS) and a cloudy time for routing more power from the longer-term BESS (e.g., a majority of the power during the cloudy time being routed from the longer-term BESS (and less than 50% of the power during the cloudy time being routed from the shorter-term BESS); at least 60% of the power during the cloudy time being routed from the longer-term BESS; at least 70% of the power during the cloudy time being routed from the longer-term BESS; at least 80% of the power during the cloudy time being routed from the longer-term BESS; at least 90% of the power during the cloudy time being routed from the longer-term BESS; or exclusively routing power during the cloudy time from the longer-term BESS).

One example of load-based control is based on needs of the load. As discussed above, the shorter-term BESS may be assigned to supply more or all power during certain periods and the longer-term BESS may be assigned to supply more or all power during other periods. In such respective periods, the load may further dictate how much power for the respective BESS to supply (e.g., periods of higher load results in the respective BESS supplying more power; conversely, periods of lower load results in the respective BESS supplying less power).

One example of amount of power based control is responsive to determining the amount of power available from a respective BESS. As discussed herein, the shorter-term BESS may be assigned to supply more or all power during certain periods and the longer-term BESS may be assigned to supply more or all power during other periods. In such respective periods, the amount of power in the respective BESS may further dictate how much power for the respective BESS to supply (and, in turn, how much load is powered). As one example, periods of higher power generated (e.g., from an especially sunny day where the shorter-term BESS is tasked with primarily or entirely providing power during the day (see herein)) may result in the respective BESS supplying more power, with the control system throttling up the load's consumption of power (e.g., as a variable-use load, discussed further below); conversely, periods of lower power generated (e.g., from an especially cloudy day where the shorter-term BESS is tasked with primarily or entirely providing power during the day (see herein)) may result in the respective BESS supplying less power, with the control system throttling down the load's consumption of power.

Thus, various controls are contemplated for any one, any combination, or all of: the shorter-term BESS; the longer-term BESS; or the load. As one example with regard to control of the load, power to the load may be ramped upward or downward based on any one, any combination, or all of the shorter-term BESS, the longer-term BESS, or the load. In one instance, the load (e.g., the data center, discussed further below) may have an associated load utilization schedule as part of a load shed scheme. In such an instance, the load utilization schedule may be used to indicate to the control system (controlling the routing of power from the resource(s), including routing from the renewable generation source(s) and/or the BESS to the load) when and how much power to route to the load from any one, any combination, or all of: a first renewable generation source; a second renewable generation source; the shorter-term BESS; or the longer-term BESS. Alternatively, or in addition, amount of power stored in one or both of the shorter-term BESS or the longer-term BESS may determine how much power to route to the load (e.g., ramping upward and/or downward the power routed to the load based on the amount of power in the respective BESS). In one or some embodiments, a respective load may have a baseline amount of power needed (e.g., a minimum load for the electrolyzers). Given this information, the control system may ramp the power to the load upward and/or downward based on the amount of power in the respective BESS, while still meeting the baseline amount of power needed for the load.

Generally speaking, the one or more energy resources (including one or more renewable energy resources and/or one or more traditional energy resources (e.g., fossil-fuel based energy resources)) generate energy for use by one or more loads. Various loads are contemplated, including different types of loads.

One example type of load comprises a variable-use load in which the energy used may be variable. One example variable-use load may vary based on internal controls within the load (e.g., throttling energy use upward and/or downward based on needs of the load, such as a heating, ventilation, and air conditioning (HVAC) system that may throttle up use during the day and throttle down use at night). Another example variable-use load may vary based on external controls, such as a controller external to the load (e.g., throttling energy use upward and/or downward based on the availability (or lack thereof) of energy so that part or all of the load may throttle upward or downward based on the amount of energy available, such as discussed below with regard to throttling operations upward and/or downward at a hydrogen plant).

Another example type of load comprises a constant- or stable-use load in which the energy used is constant, stable, or non-varying. One example constant-use load comprises a data center, which may (by contract or actual need) require a constant amount of power provided thereto.

Thus, one example load may comprise a hydrogen system that is configured to generate hydrogen, such in the form of a gas or in liquid form. Hydrogen gas may be produced using diverse, domestic resources. In one example, fossil fuels, such as natural gas and coal, may be converted to produce hydrogen, and the use of carbon capture, utilization, and storage may reduce the carbon footprint of these processes. In another example, hydrogen gas may also be produced by a “green” hydrogen system from low carbon and renewable resources, including biomass grown from non-food crops and splitting water using electricity from wind, solar, geothermal, nuclear, and hydroelectric. In this regard, green hydrogen may refer to hydrogen gas that is produced using renewable energy in whole or in part.

In one or some embodiments, the renewable energy resources may be electrically connected to the load(s) via a grid. Various types of grids are contemplated. One example grid comprises a power grid (interchangeably termed a grid or a macrogrid), which is an interconnected network for electricity delivery from producers to consumers. Power grids typically include power stations (interchangeably a power plant, generating station, or generating plant) that generate power; electrical substations (interchangeably termed substations) that step the voltage up or down; and electrical power distribution where the voltage is stepped down again to the required service voltage(s) for the end customers.

In certain instances, the power grid may work in combination with a microgrid, which may comprise a local electrical grid with defined electrical boundaries that acts as a single and controlled entity. A specific type of microgrid is a stand-alone microgrid, which has its own source of electricity (e.g., one or both of generation sources or energy storage, such as batteries). The microgrid may operate in different modes of operation, such as grid-tied (interchangeably termed grid-connected) or islanded (interchangeably termed in island mode or off-grid). A grid-tied microgrid may operate connected to and synchronous with the power grid (e.g., the macrogrid). The islanded microgrid may be electrically disconnected from the power grid and may function autonomously from the power grid with local loads connected in circuit. In this regard, the microgrid may transition from grid-tied to islanded and vice-versa.

Another type of grid comprises a microgrid, which may comprise a local electrical grid with defined electrical boundaries, acting as a single and controllable entity, and able to operate in grid-connected mode (e.g., electrically connected to the power grid) and in island mode (e.g., electrically disconnected from the power grid). Microgrids tend to integrate multiple energy technologies and unique circumstances into a single project, making them complicated and challenging. Each project may comprise different electric generation types and sizes, serve a unique load, be situated in a unique geography and market, and be subject to unique weather variability and regulations.

Historically, microgrids generated power using fossil fuel-fired combined heat and power (CHP) and reciprocating engine generators. Current technology is increasingly leveraging more sustainable resources like solar power and energy storage. Microgrids may run on renewables, natural gas and/or other combustible fuels, or emerging sources such as green hydrogen and fuel cells. Green hydrogen is seen as a promising emerging energy source because it may be used as a clean fuel for transportation and energy storage, and as a feedstock for industrial processes that currently rely on fossil fuels. However, production of green hydrogen is currently more expensive than traditional methods and has challenges in scaling up production to meet demand.

As discussed above, in one or some embodiments, a plurality of renewable energy sources are controlled in combination. Typically, respective renewable energy sources may have benefits and drawbacks, such as in terms of costs to generate energy and/or stability of the respective renewable energy source, as discussed above. Further, typically, the respective renewable energy source is controlled in isolation, without consideration for or interaction with another renewable energy source. Thus, in one or some embodiments, the combined control of the renewable energy sources may capitalize the benefits and reduce the drawbacks, including more efficiently operate the renewable energy sources and/or increase the stability of the respective renewable energy sources (e.g., stability of the operation of the respective renewable energy source(s) and/or the stability of the amount of power generated by one, some or all of the respective renewable energy source(s)).

As discussed in more detail below, various renewable energy sources are contemplated, including any one, any combination, or all of: solar energy system(s) (e.g., photovoltaic system; concentrated solar power system; etc.); wind power system(s); hydropower system(s) (e.g., tidal energy system; hydroelectric dam system; etc.); bioenergy system(s); or geothermal power system(s).

Various ways are contemplated in which the plurality of renewable energy systems may be controlled (such as automatically controlled) in combination. In one way, the energy generated from a first renewable energy system may be automatically routed to a second renewable energy system. By way of example, a first renewable energy system may comprise a first renewable energy source (e.g., a first PV system) working with a first battery system (e.g., a shorter-term BESS). In one or some embodiments, the energy generated by the PVs in the first PV system and/or the energy stored in the battery system may be used for one or more aspects of operation of a second renewable energy system that may comprise a second renewable energy source, (e.g., a CSP, wind, or a second PV system) working with a second battery system (e.g., a longer-term BESS, such as a long duration energy storage (LDES) system).

The LDES system may refer to systems that include technology for storing energy in various forms including any one, any combination, or all of chemical, thermal, mechanical, or electrochemical. These resources may dispatch energy in one or more forms (e.g., heat) for extended periods of time, such as ranging from 8 hours, to days, weeks, or seasons. For example, some LDES technologies can discharge both heat and power (e.g., power-to-heat or heat-to-power) that can be used to decarbonize industries, or can use power to produce hydrogen via electrolysis, which can be reconverted back to power at a later time.

With regard to mechanical LDES, one type is pumped storage hydroelectricity (PSH), a form of mechanical storage. Various versions of this established technology may be used to reduce its dependence on geographical conditions, for example, geomechanical pumped hydro, which may use the same principles as aboveground PSH but with subsurface water reservoirs. Other mechanical energy storage solutions include compressed air energy storage (CAES) and gravity-based energy storage. The first stores energy as compressed air in pressure-regulated structures (either underground or aboveground). In its adiabatic form, CAES may also include thermal storage to store the heat that is generated during compression and may reuse it in the discharge cycle. Gravity-based energy storage is another form of mechanical storage, which stores energy by lifting mass that is released when energy is needed. Lastly, mechanical LDES may take the form of liquid CO2, which may be stored at high pressure and ambient temperature and then released in a turbine in a closed loop without emissions.

Thermal LDES may store electricity or heat in the form of thermal energy. In the discharge cycle the heat may be transferred to a fluid, which may then be used to power a heat engine and discharge the electricity back to the system. Depending on the principle used to store the heat, thermal energy storage may be classified into sensible heat (increasing the temperature of a solid or liquid medium), latent heat (changing the phase of a material), or thermochemical heat (underpinning endothermic and exothermic reactions). These technologies may use different mediums to store the heat such as molten salts, concrete, aluminum alloy, or rock material in insulated containers. Likewise, the charging equipment options are diverse, including resistance heaters, heat engines, or high temperature heat pumps among others. Another thermal LDES technology are molten salts coupled with concentrated solar power (CSP) plants, discussed further below. In this regard, molten salts may effectively be used in thermal LDES to store electricity independently of CSP plants. Thermal LDES technologies may discharge both electricity and heat, supporting the decarbonization of the heat sector.

With regard to electrochemical LDES, different batteries of varying chemistries are contemplated to provide longer duration flexibility (e.g., aqueous flow batteries; metal anode batteries; or hybrid flow batteries). Electrochemical flow batteries may store electricity in two chemical solutions that are stored in external tanks and pushed through a stack of electrochemical cells, where charge and discharge processes may occur due to a selective membrane. These batteries may be suited for longer-duration applications where low chemical and equipment costs are possible. There may also be hybrid flow batteries with liquid electrolytes and a metal anode, which may combine some of the properties of conventional flow batteries and metal-anode systems.

Chemical LDES may store electricity through the creation of chemical bonds. Two technologies are based on power-to-gas concepts including: (1) power-to-hydrogen-to-power; and (2) power-to-syngas (synthetic gas)-to-power. In the first case, electricity may be used to power electrolyzers, which may produce hydrogen molecules that may be stored in tanks, caverns, or pipelines. The energy may be discharged when the hydrogen is supplied to a hydrogen turbine or fuel cell. If the hydrogen is combined with CO2 in a second step to make methane, the resulting gas (known as syngas) may have similar properties to natural gas and may be stored and later burned in conventional power plants. Similarly, hydrogen may be converted to ammonia for direct combustion.

In one or some embodiments, the second renewable energy system may use heat to operate one or more turbines. As such, the first renewable energy system may supply DC electrical power, converted to heat, in order to at least partly operate the one or more turbines. In this regard, the energy supplied by one or both of the PV system or the battery system (e.g., the shorter-term BESS) may be used to automatically control one or more aspects of operation of the second renewable energy source and the LDES system. As discussed in more detail below, an amount of power routed from one or both of the PV system or the battery system may be dependent on one or both of: the first renewable energy source or the battery system (e.g., current or forecasted future operation of the first PV system and the battery system); or the second renewable energy source and the LDES system (e.g., current or forecasted future operation of second renewable energy source and the LDES). Alternatively, or in addition, an amount of power routed from one or both of the second renewable source and the LDES system may be dependent on one or both of: the first PV system and the battery system (e.g., current or forecasted future operation of the first PV system and the battery system, such as current or forecasted future charge of the battery system); or the second renewable energy source (e.g., current or forecasted future operation of the second renewable energy source and the LDES system). In particular, the second renewable source and the LDES system may supply energy to the battery system (e.g., excess AC power from the second renewable source and the LDES system may be converted to DC power and stored in the battery system). In turn, management of the energy supplied to the first renewable energy source and the battery system may be used for automatically supplying power to load(s) assigned to the first renewable energy source and the battery system, as discussed further below. In this way, automatic control of the first renewable energy system and the second renewable energy system is not performed in isolation. Rather, the automatic control of both of the first renewable energy system and of the second renewable energy system is performed in combination in a synergistic manner.

Further, in one or some embodiments, the plurality of renewable energy systems may comprise at least three separate renewable energy systems that may be automatically controlled in combination.

In addition, the multiple renewable energy systems and one or more loads may be automatically controlled in combination. As one example, the multiple separate renewable energy systems may comprise a first renewable energy system that includes a first renewable energy source (e.g., a first PV system) working with a battery system, a second renewable energy system that includes second renewable energy source(s) (e.g., wind, CSP, or second PV system, and the like) working with an LDES system. The first and second renewable energy systems may be connected (such as electrically connected) to the load, which may comprise a hydrogen (H2) system (discussed further below for efficient green hydrogen production), a data center, and the like. In this regard, any one, any combination, or all of the first renewable energy source, the battery, the second renewable energy source, the LDES system, and the load may comprise a hybrid plant system. In one or some embodiments, the automatic common control may route power from one or more of the renewable energy systems to one or more of the remaining renewable energy systems and to the load. As one example, power may be automatically routed from one or both of the first renewable energy source and the battery system, or the second renewable energy source(s) and the LDES system to the load. Thus, in one or some embodiments, any one, any combination, or all of the first renewable energy source, the battery, the second renewable energy source, the LDES system, and the load may be controlled in combination so that any one, any combination, or all of the first renewable source and the battery system, the second renewable source and the LDES system, and the load may supply power to any one, any combination, or all of a remaining one(s) of the battery system (e.g., the shorter-term BESS), the second renewable energy source and the LDES system, and the load. In this regard, any disclosed energy system(s) may be controlled to supply power to any one, any combination, or all of the remaining disclosed energy system(s).

Various triggers are contemplated to cause the controller to automatically command the transfer energy from first renewable energy system(s) to a second renewable energy system(s) (e.g., from one or more of the first renewable energy source and battery system, the second renewable energy source and the LDES system, or the load to one or more of the remaining of the battery system, the second renewable energy source and the LDES system, or the load). In one or some embodiments, the trigger may be dependent on one or both of operations of the first renewable energy system(s) or operations of the second renewable energy system(s). In particular, the trigger may focus on operations of the first renewable energy system(s), which may supply the energy to the second renewable energy system(s). In one example, the first renewable energy system and/or the battery system may have excess power. In such an instance, responsive to the controller automatically determining that there is excess power, the controller may automatically route part or all of the excess power to another renewable energy system, such as to the second renewable energy source and the LDES system, and/or to the load (e.g., the hydrogen system). Alternatively, or in addition, the second renewable energy source and the LDES system may have excess power, thereby triggering the controller to automatically route part or all of its excess power to the first renewable energy source and battery system and/or the load (e.g., the hydrogen system). In one or some embodiments, power generation systems and storage systems may be used as auxiliary or supplemental power for support to each other and/or any component of the load (e.g., the electrolyzer of the hydrogen system).

Alternatively, the trigger may focus on operations of the second renewable energy system(s), which may receive the energy supplied by the first renewable energy system(s). In one example, the hybrid plant system may require energy for operations (e.g., energy to operate the electrolyzer and/or compressor(s)). Responsive to the controller automatically determining the hybrid plant system requires energy for operating, the controller may automatically route energy from any one, any combination, or all of the first renewable energy source and battery system or the second renewable energy source and the LDES system.

As discussed above, the controller may automatically route power responsive to determining an excess in power. Excess power may be defined in one or more ways. In one way, excess power may be automatically determined based on one or both of: (i) automatically determining the energy stored and/or produced by the respective renewable energy system(s); or (ii) automatically determining the current or estimated energy needed for respective load(s) assigned to the respective renewable energy system(s). In particular, in one or some embodiments, each renewable energy system may be assigned respective separate load(s). As one example, the first renewable energy and the battery system may be assigned to supply power for a first grid (e.g., a first respective microgrid; a first portion of the electrical grid). As another example, the second renewable energy source and the LDES system may be assigned to supply power for a second grid (e.g., a second respective microgrid; a second portion of the electrical grid). As such, the automatic determination of whether there is excess power for respective renewable energy system(s) may be automatically determined based on the power requirements for the assigned respective load(s). In the instance of the first renewable energy source and the battery system, the controller may automatically determine, based on the current and/or projected power requirements for the first grid, that the first renewable energy source or the battery system have (or will have) excess power. In response to the automatic determination, the controller may automatically route part or all of the excess power to a second renewable energy system, such as to the second renewable energy source and the LDES system. Similarly, in the instance of the second renewable energy source and the LDES system, the controller may automatically determine, based on the current and/or projected power requirements for the second grid, that the second renewable energy source and the LDES system have (or will have) excess power. In response to the automatic determination, the controller may automatically route part or all of the excess power to a first renewable energy system, such as to the first energy source and the battery system.

Alternatively, or in addition, two or more renewable energy systems may have commonly assigned respective load(s). In the example given above, both the first renewable energy source working with the battery system and the second renewable energy source working with the LDES system may be assigned to supply power to a same grid, such as the same microgrid. In such an instance, the controller may automatically determine, based on the current and/or projected power requirements for the same microgrid, whether to automatically route energy from one or more of the two or more renewable energy systems to another one or more of the remaining renewable energy systems. In this regard, the controller may be automatically configured to address one or more issues, such as or both of: transient weather; or excess power. As one example, transient weather may result in the second renewable energy source and the LDES system being unable to collect heat, and therefore would require external power from any one, any combination, or all of the first renewable energy source, the battery system (e.g., the shorter-term BESS), or the grid. As another example, in the case of overproduction (e.g., in summer/spring/fall months), excess power (such as if the electrolyzer of the hydrogen system is at 100% utilization and batteries are 100% charged) may be routed (e.g., sold) back to the grid (e.g., the utility grid, the microgrid, etc.).

As discussed above, energy may be routed from one renewable energy system to another renewable energy source and/or to the load (e.g., an automatic control of the load to increase its energy usage). Energy may take one of several forms, such as electrical power (e.g., DC electrical power; AC electrical power), heat, or the like. As such, in one or some embodiments, common control of the renewable energy systems may include conversion (such as automated conversion) of energy in one form from a first renewable energy system to another form for use by a second renewable energy system. Thus, in one or some embodiments, the controller may be configured to automatically command the conversion of energy amongst the different renewable energy systems so that energy supplied by a first renewable energy system (which operates with a first type of energy) may be used by a second energy system (which operates with a second type of energy). As merely one example, a second renewable energy system may include a CPS system working with the LDES system and may operate based on heat. As such, the transfer of energy from the first renewable system including a PV system and the battery system, which supply DC electrical power, may first be converted into heat (e.g., via heaters, and potentially heat exchangers, powered by the DC electrical power). Other conversions of energy (such as DC power to AC power, and vice-versa) are contemplated.

Further, various aspects of the controller and the control are disclosed as automated. Any one, any combination, or all of the aspects of the controller and the control may be completely automated without any operator input. Alternatively, any one, any combination, or all of the aspects of the controller and the control may be automated (such as any automatic action performed by the controller as disclosed herein) to request an operator input to authorize the controller to act automatically. Responsive to the controller receiving the operator input, the controller may act automatically.

Thus, in one or some embodiments, a method and system are disclosed for combined and integrated control of a hybrid plant system. In one or some embodiments, the hybrid plant system may comprise any two or more different renewable energy sources. The hybrid plant system may be used in a variety of applications. For example, the hybrid plant system may be used for efficient hydrogen production by integrating any one, any combination, or all of CSP, PV, electrolysis, and energy storage technologies (e.g., batteries). Though, the green hydrogen production application is merely one example; other applications (such as a data center application) are contemplated.

Thus, the hybrid plant system may be used to produce hydrogen with renewable energy at a low cost while delivering sufficient power to meet power demands. Existing technology relies on grid power, which may limit the amount of hydrogen available for multiple industries (e.g., fuel, methanol, fuel cells, and the like). As noted above in the background, current interconnection costs and power rates are too high to implement a dedicated plant that may provide off-grid/islanded microgrid functionality.

The disclosed systems and methods provide the capability of isolation of sections of the grid with critical facilities, with the end-user loads continuing to receive power from different renewable assets (e.g., CSP and PV) with minimal operator action and no interruption in power.

In one or some embodiments, the disclosed systems and methods may increase, such as maximize, the generation or production of power to the electrolyzer of a hydrogen system with the final goal of maximum hydrogen production while minimizing consumption from the power grid and the levelized cost of energy (LOCE) by integrating and controlling the energy flow of different renewable assets to create electricity and steam for use in production of green hydrogen. Alternatively, or in addition, the disclosed systems and methods may provide a more stable and reliable power output or energy flow for the combination of different renewable assets.

The disclosed systems and methods may thus integrate various technologies including two different solar-based technologies: PV and CSP. These two technologies may be similar in that they both use the sun in order to generate power/energy. But beyond that, they are considerably different in operation. Nevertheless, the disclosed systems and methods provide integrated control of PV and CSP systems for greater efficiency and/or greater stability of power output.

In one or some embodiments, the primary resource for CSP systems is the direct solar irradiance perpendicular to a surface that continuously tracks the sun (direct normal irradiation, or DNI). In contrast, non-concentrating systems, such as PV systems, use global irradiation (direct fraction of the sunlight as well as the diffuse fraction).

In one or more embodiments, in terms of energy storage and efficiency, CSP systems may store energy with the help of LDES systems including thermal storage unit (TES) technologies. PV systems, on the other hand, are incapable of producing or storing thermal energy or any other dispatchable power since they directly generate electricity. Aside from that, it may be difficult to store electricity using current systems.

Although CSP systems may be more efficient than PV systems in terms of energy saving, PV systems may include cheaper technology hardware.

In one or more embodiments, a power grid typically focuses on providing reliable and stable power in the electric grid. However, this may be difficult, particularly when parts of the grid may be temporarily unavailable to provide power. The disclosed systems and methods further provide a unique way to address the considerable electricity cost associated with production of hydrogen. By using renewable assets, the disclosed systems and methods further avoid monetary and efficiency loss associated with sales to the power grid and equipment efficiency loss. In particular, having an off-grid microgrid provides a disconnected system with autonomous controls that facilitates optimized operation around seasonal and daily/nightly power and environmental conditions.

In one or more embodiments, since the electric grid should always be balanced so that electricity generation exactly equals electricity usage, there are times when there is more electricity available than may possibly be used. This excess electricity results in curtailment of renewables, which is a purposeful reduction in renewable electricity output below the levels that could otherwise have been produced. The disclosed systems and methods may enable curtailed energy to be used to provide energy for when the CSP system is not being operated.

In one or more embodiments, hydrogen electrolyzers may require constant operation to be cost feasible. The disclosed hybrid plant system may facilitate a low-cost power source to be able to support, for example, the load requirements of a hydrogen proton exchange membrane (PEM) for 24/7 plant operation. The disclosed systems and methods further reduce the capital cost of the electrolyzer unit and the balance of the system and improve energy efficiency for converting electricity to hydrogen over a wide range of operating conditions.

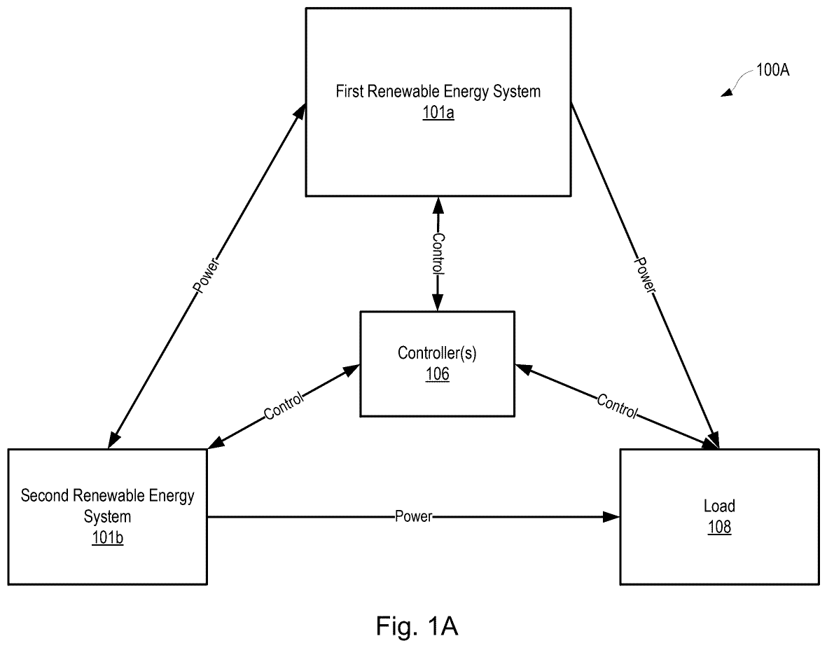

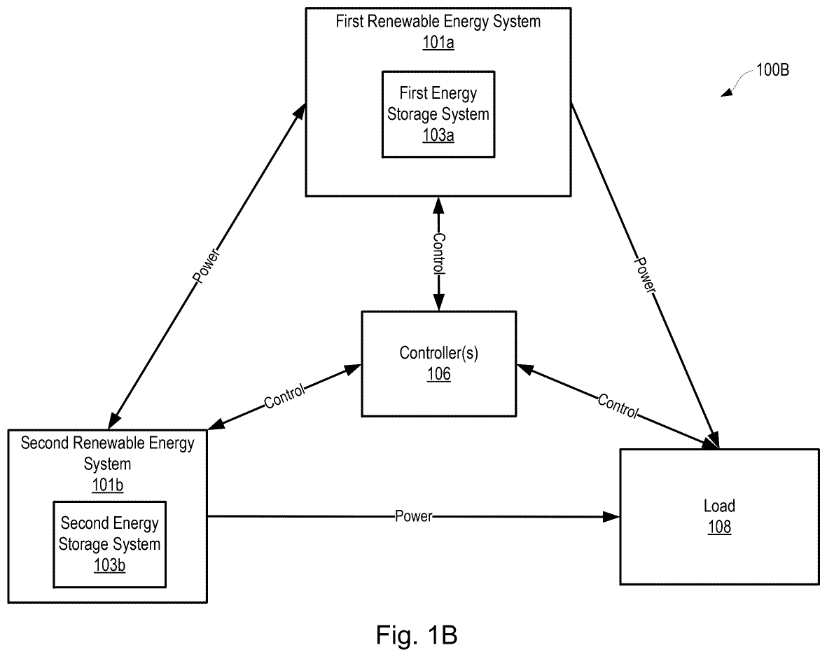

Various implementations of the hybrid plant system are contemplated, such as depicted in FIGS. 1A-6. For example, FIG. 1A depicts a block diagram 100A of a hybrid plant system for implementing the disclosed systems and methods. In one or some embodiments, the hybrid plant system includes a first renewable energy system 101a, a second renewable energy system 101b, and controller(s) 106 in communication with (e.g., coupled therewith) the first renewable energy system 101a, the second renewable energy system 101b, and the load 108. The load 108 may include one or more different loads (e.g., a hydrogen system, a data center, and the like). The controller(s) 106 may include at least one controller (e.g., a master controller). In this regard, any discussion regarding a controller may comprise a single controller or multiple controllers. Further, FIG. 1A (and other figures) depict power lines and control lines. As shown in FIG. 1A, the control lines are double-arrowed, indicating that the controller may, in one direction, provide commands or instructions, and in another direction, receive data (e.g., status and the like).

In one or some embodiments, the first renewable energy system 101a may be configured to generate a first source of energy. The second renewable energy system 101b may be configured to generate a second source of energy. In one or some embodiments, the second source of energy may be of a different type than the first source of energy.

In one or some embodiments, the controller 106 may be configured to receive a respective status for the first renewable energy system 101a, the second renewable energy system 101b, and the load 108. The respective status of the first renewable energy system 101a may be indicative of forecasted and/or real-time generated energy of the first renewable energy system 101a. The respective status of the second renewable energy system 101b may be indicative of the forecasted and/or real-time generated energy of the second renewable energy system 101b. The respective status of the load 108 may be indicative of operation of the load 108 (e.g., past operation, current operation, and/or future operation (e.g., load utilization schedule). The controller 106 may be further configured to automatically determine and automatically perform common control of at least two or all of the first renewable energy system 101a, the second renewable energy system 101b, and the load 108.

In one or some embodiments, the common control comprises automatically routing the energy from one of the first renewable energy system 101a or the second renewable energy system 101b to another of the first renewable energy system 101a or the second renewable energy system 101b.

In one or some embodiments, the respective status of the first renewable energy system 101a may comprise the forecasted and/or real-time generated energy of the first renewable energy system 101a. Further, the common control comprises automatically routing the energy from the second renewable energy system 101b to the first renewable energy system 101a based on the forecasted and/or real-time generated energy of the first renewable energy system 101a. As further explained below, the forecasted generated energy may comprise a seasonal forecast which may comprise a daily or weekly forecast. The real-time generated energy may comprise the real-time indication as to the amount of energy generated

In one or some embodiments, the automatic common control comprises automatically controlling operation of the load 108 based on combined energy of the first renewable energy system 101a and the second renewable energy system 101b.

In one or some embodiments, the first renewable energy system 101a, the second renewable energy system 101b, and the load 108 may be co-located.

In one or some embodiments, at least one of the first renewable energy system 101a or the second renewable energy system 101b may include at least one byproduct. The common control comprises routing the at least one byproduct from the at least one of the first renewable energy system 101a or the second renewable energy system 101b for use by the load 108. In particular, the at least one byproduct may be water-based, such as comprise heated water and/or steam, and the common control may comprise routing the heated water and/or steam for use by the load 108.

FIG. 1B depicts a block diagram 100B of a hybrid plant system for implementing the disclosed systems and methods. In one or some embodiments, the first renewable energy system 101a may include a first energy storage system 103a. The first renewable energy system 101a may be configured to generate the first source of energy and store, in the first energy storage system 103a, at least a part of the energy generated by the first source of energy. The second renewable energy system 101b may include a second energy storage system 103b. The second renewable energy system 101b may be configured to generate a second source of energy and store, in the second energy storage system 103b, at least a part of the energy generated by the second source of energy.

In one or some embodiments, the respective status of the first renewable energy system 101a may be indicative of the stored energy and/or the forecasted generated energy of the first renewable energy system 101a. The respective status of the second renewable energy system 101b may be indicative of the stored energy and/or the forecasted generated energy of the second renewable energy system 101b.

In one or some embodiments, the first energy storage system 103a may comprise a shorter-term energy storage system (e.g., a lithium-based battery system, sodium-ion battery system, a BESS system, and the like) and the second energy storage system 103b may comprise a longer-term energy storage system (e.g., such as long duration energy storage (LDES) system). In particular, the common control may be indicative of routing the energy between the shorter-term energy storage system and the longer-term energy storage system.

In one or some embodiments, the common control for routing the energy between the shorter-term energy storage system and the longer-term energy storage system is based on one or both of the forecasted generated energy of the first renewable energy system 101a or the forecasted generated energy of the second renewable energy system 101b.

In one or some embodiments, the common control for automatically routing the energy between the shorter-term energy storage system and the longer-term energy storage system may be based, at least in part, on real-time generated energy of the first renewable energy system 101a and/or real-time generated energy of the second renewable energy system 101b.

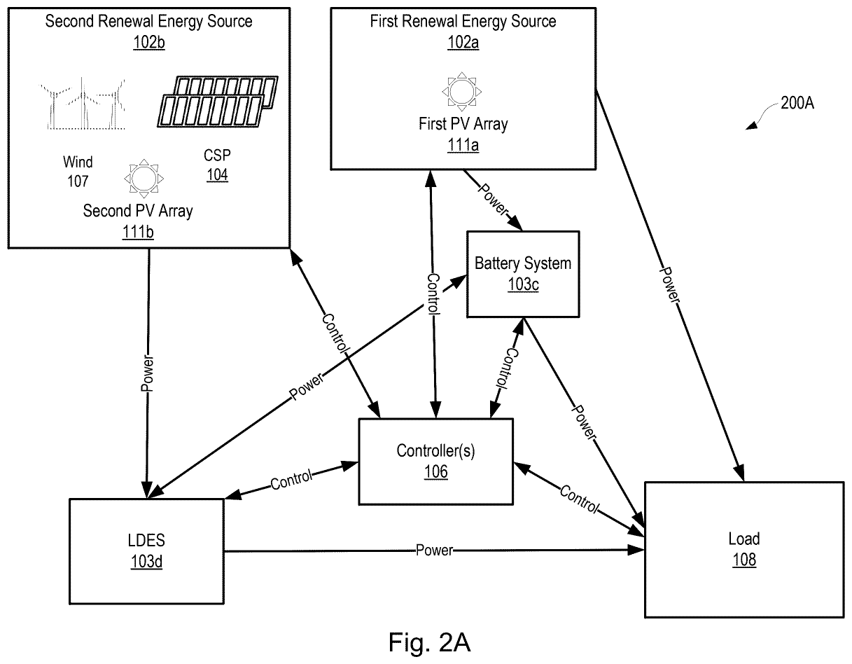

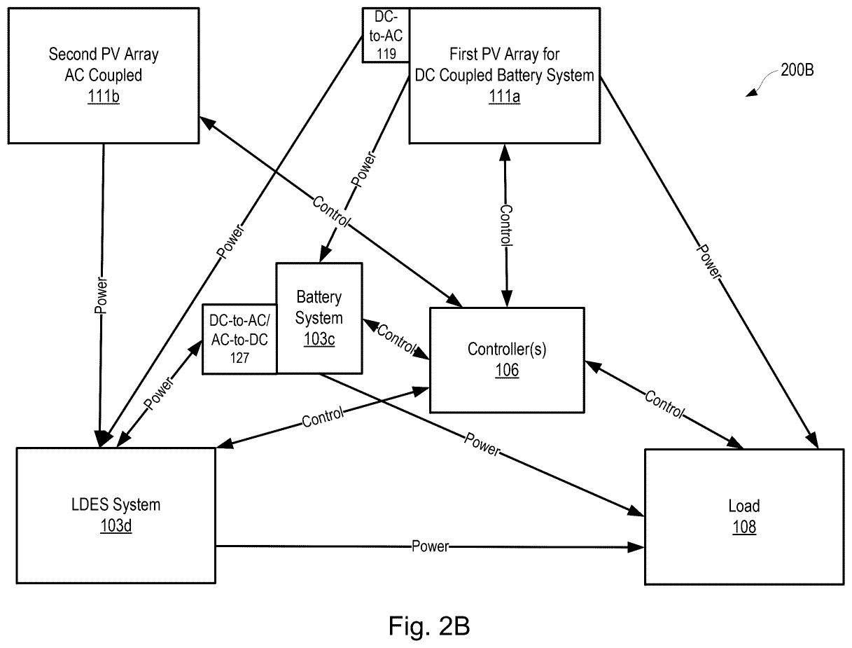

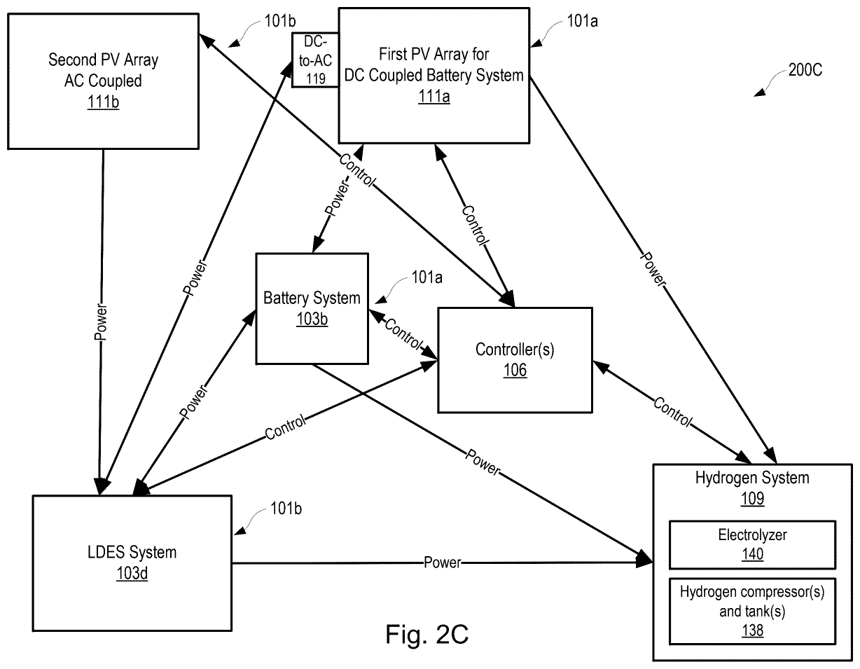

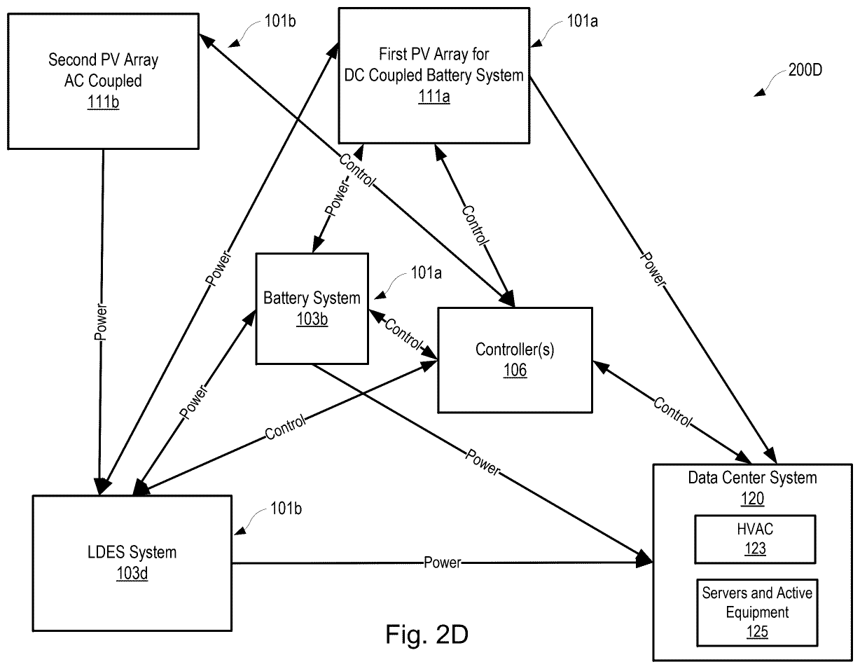

FIG. 2A depicts a block diagram 200A of a hybrid plant system for implementing the disclosed systems and methods. In one or some embodiments, the first renewable energy system 101a may include a first renewable energy source 102a working with a shorter-term energy store system (e.g., a battery system 103c)). FIG. 2A depicts that first renewable energy source 102a comprises first PV array 111a; alternatively, or in addition, first renewable energy source 102a may include wind, CSP, or other type(s) of renewable energy sources. In particular, as mentioned above, the first renewable energy system may comprise a first PV array 111a working with the battery system 103c (e.g., a DC Coupled Battery System, such as a lithium battery, BESS, and the like).

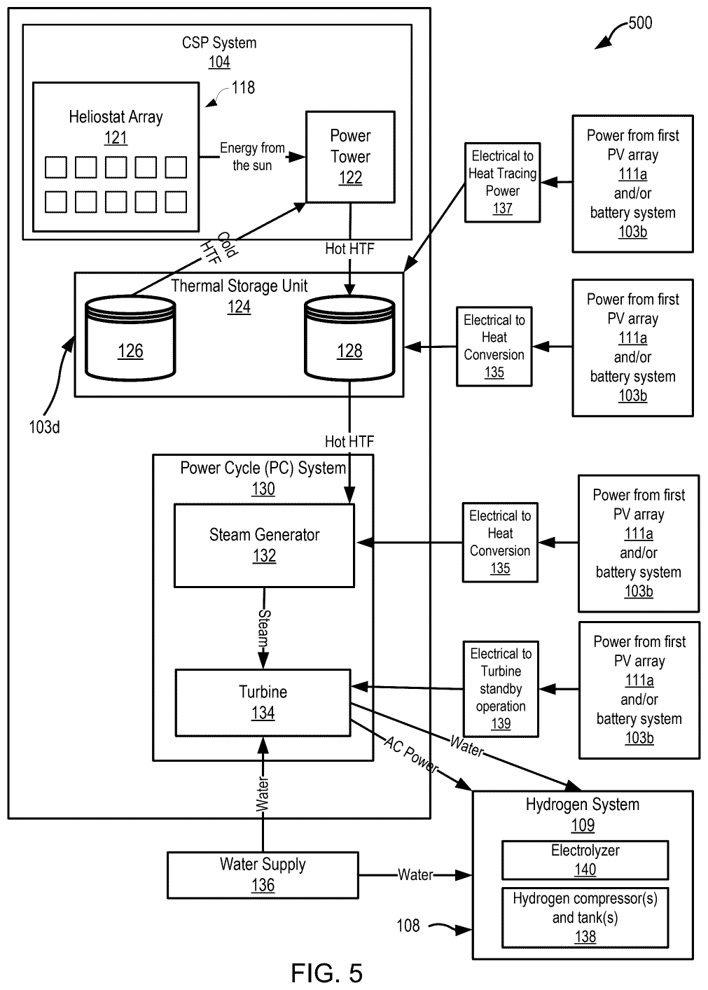

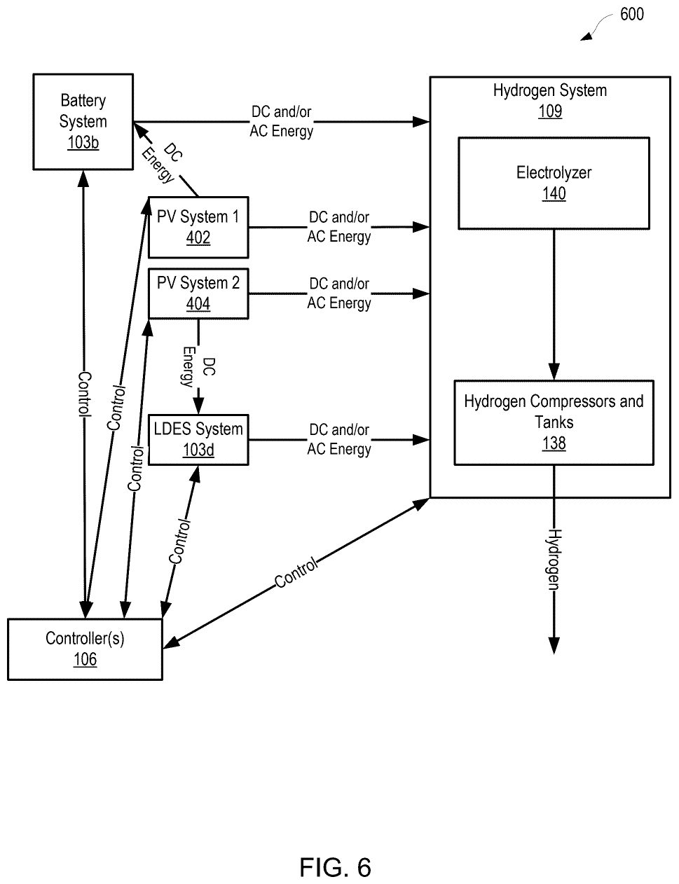

The second renewable energy system 101b may include a longer-term energy storage system that may comprise second renewable energy source 102b, which may comprise any one, any combination, or all of: CSP system 104; wind power 107; or second PV array 111b. (e.g. an LDES system 103d). The LDES system 103d may be coupled with a second renewable asset/energy source. In particular, in some embodiments, the second renewable energy system may comprise a second renewable energy source that may include a CSP system 104 working with the LDES system 103d as shown in FIGS. 5 and 6. It should be appreciated that the LDES system 103d is not limited to work with a CSP system 104; rather the LDES system 103d may work (e.g., may be coupled) with any renewable asset such as CSP system 104, wind power 107, a second PV array 111b, hydropower, and/or biomass.

First PV array 111a of the first renewable energy source 102a may be configured to directly convert solar irradiation to generate a first source of energy (e.g., DC electrical power). In particular, the first PV array 111a may include a type of renewable energy technology that makes use of the sun's light to generate energy. In other words, the first PV array 111a directly converts the sun's light into electrical power, which is one form of energy. In one or some embodiments, energy generated by the first PV array 111a may be routed, under control of controller 106, to LDES system 103d (e.g., after DC to AC conversion using DC-to-AC converter 119).

The battery system 103c may be configured to store energy. In one or some embodiments, the battery system 103c may be configured to store at least a part of the first source of energy. The battery system 103c may include an energy storage system that uses rechargeable batteries to store energy from a power source, such as a power grid, wind, or solar power. The battery system 103c may include various types of storage of power for later use. As one example, the battery system 103c may include batteries, such as Battery Energy Storage Systems (BESS).

The CSP system 104 may be configured to concentrate solar energy to generate a second source of energy (e.g., heat). In one or some embodiments, the CSP system 104 may include a type of renewable energy technology that uses mirrors or lenses to focus large amounts of sunlight onto a small area. Unlike the first PV array 111a which uses the sun's light, the CSP system 104 makes use of the sun's energy, in the form of the concentrated sunlight, to generate heat, which is another form of energy. In turn, at least a part of the heat may be used to drive a turbine or other means to generate alternating current (AC) electrical power. Another part of the heat may be stored in molten salt (or any other HTF (heat transfer medium)), allowing the energy to be used later when there is insufficient sunlight.

In one or some embodiments, the controller 106 may be in communication with any one, any combination, or all of the first renewal energy source 102a, the battery system 103c, the second renewal energy source 102b, and the LDES system 103d. The controller 106 may be configured for integrated control to route a respective source of energy from one renewable energy system to another renewable energy system (e.g., the first source of energy, from the First PV array 111a or the battery system 103c routed to operate one or more parts of the second renewable energy source 102b (e.g., the CSP system 104), the LDES system 103d, and/or one or more parts of the load 108). Alternatively, or in addition, the controller 106 may also provide integrated control to route the second source of energy, from the second renewable energy source 102b (e.g., the CSP system 104) to the battery system 103c. As discussed above, conversion from one energy source to another energy source may be a predicate step in the transfer of power between different renewable energy systems. As one example with regard to transfer of power from the CSP system 104 to the battery system 103c, heat from the CSP system 104 may be converted into electrical power (such as DC electrical power) in order to store the converted electrical power in the battery system 103c. As another example, the AC output from a turbine of the CSP system 104 may be converted to DC electrical power and then stored in the battery system 103c.

Thus, in one or some embodiments, the first renewable energy source 102a in combination with battery system 103c (e.g., a shorter-term BESS) may comprise a daytime power system for load 108, and the second renewable energy source 102b in combination with LDES 103d may comprise a nighttime power system for load 108. In one or some embodiments, both first renewable energy source 102a and second renewable energy source 102b may generate energy at the same time (e.g., during daytime) when both are PV-based systems. However, in one instance, the first renewable energy source 102a powers (e.g., the majority or entirely) the load 108 and charges battery system 103c during the day, while the second renewable energy source 102b does not power (or powers less) the load 108 during the day and charges LDES 103d during the day, and powers (e.g., the majority or entirely) the load 108 at night (while battery system 103c does not power or powers the load less at night).

In one or some embodiments, there may be one or more differences in the first PV array 111a and the second PV array 111b, including one or both of DC-to-AC ratio; or ground cover ratio. In one or some embodiments, the DC-to-AC ratio may be higher for the first PV array 111a versus the second PV array 111b. Separate from this, inverter selection for the second PV array 11b may be different from the first PV array.

As discussed above, various triggers are contemplated in automatically determining the routing, such as the automatic routing, of power from one renewable energy system or storage system to another renewable energy system or storage system. In particular, a determination of excess power may automatically trigger the controller 106 to route power. For example, the controller 106 may be configured to receive a status (e.g., data indicative of the status) from one or more of the first PV array 111a, the battery system 103c, the CSP system 104, the second PV array 111b, or the LDES system 103d. In some embodiments, the status received from the generation source of the first renewable energy source 102a (e.g., the first PV array 111a) or from the generation source of the second renewable energy source 102b (e.g., the CSP system 104) may include data indicative of the amount of generated energy, energy needed for parasitic operation, operation states (e.g., generation, standby, charging, etc.), solar irradiation received, status of the different components, weather events (e.g., for heliostat wind stowing and protection of other equipment), manual and automated events (system checks, servicing, etc.), and the like. The status received from the battery system 103c and/or the LDES system 103d may, respectively, include data indicative of the amount of energy stored in the battery system 103c and/or the LDES system 103d, operation time, battery life, storage life, and the like. Various status are contemplated, including any one, any combination, or all of: battery charge status; battery health; battery servicing; battery/CSP/electrolyzer component alarms/alerts; molten salt (or other HTF) component status; salt/HTF temps throughout the system; turbine operation states; steam pressure; or water quality checks (e.g., salinity, filtration, etc.).

Responsive to receiving the status, the controller 106 may be configured to determine control of any one, any combination, or all of: the generation source of the first renewable energy source 102a (e.g., the first PV array 11a); the battery system 103c; the generation source of the second renewable energy source 102b (e.g., the CSP system 104); or the LDES system 103d in order to modify operation (based on the received status) of one or more remaining of: the first PV array 111a; the battery system 103c; the CSP system 104; or the LDES system 103d. The controller 106 performs the control of any one, any combination, or all of: the generation source of the first renewable energy source 102a (e.g., the first PV array 111a); the battery system 103c; the generation source of the second renewable energy source 102b (e.g., the CSP system 104); or the LDES system 103d.

The controller 106 is configured to determine control of any one, any combination, or all of: the generation source of the first renewable energy source 102a (e.g., the first PV array 111a); the battery system 103c; the generation source of the second renewable energy source 102b (e.g., the CSP system 104); or the LDES system 103d in order to modify operation of any one, any combination, or all of the remaining of: the generation source of the first renewable energy source 102a (e.g., the first PV array 111a); the battery system 103c; the generation source of the second renewable energy source 102b (e.g., the CSP system 104); or the LDES system 103d based on the received status. The controller 106 may automatically determine the control by automatically determining whether to route a respective source of energy from any one, any combination, or all of: the generation source of the first renewable energy source 102a (e.g., the first PV array 111a); the battery system 103c; the generation source of the second renewable energy source 102b (e.g., the CSP system 104); or the LDES system 103d to another of: the generation source of the first renewable energy source 102a (e.g., the first PV array 111a); the battery system 103c; the generation source of the second renewable energy source 102b (e.g., the CSP system 104); or the LDES system 103d.

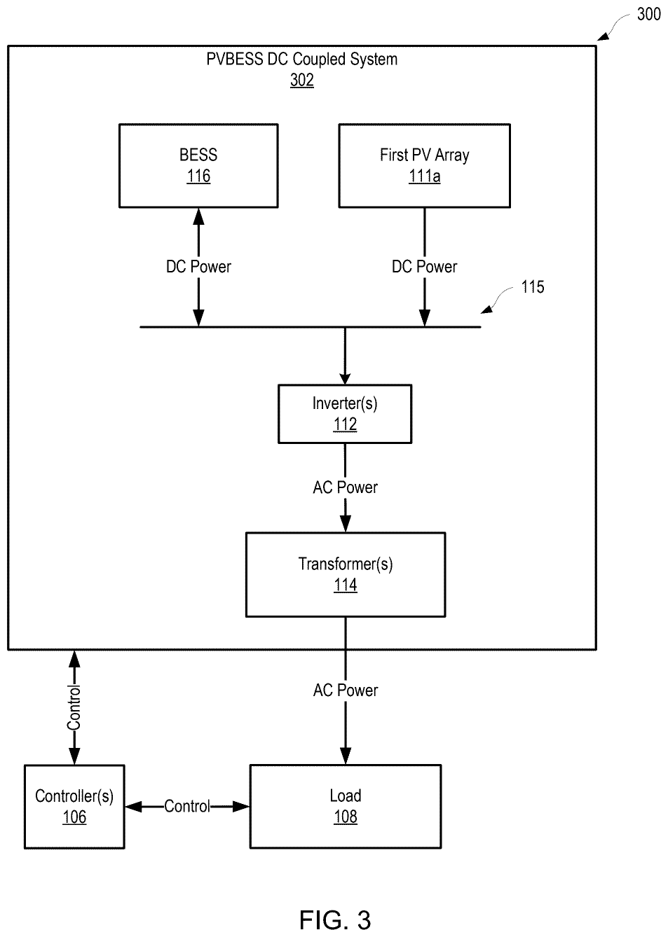

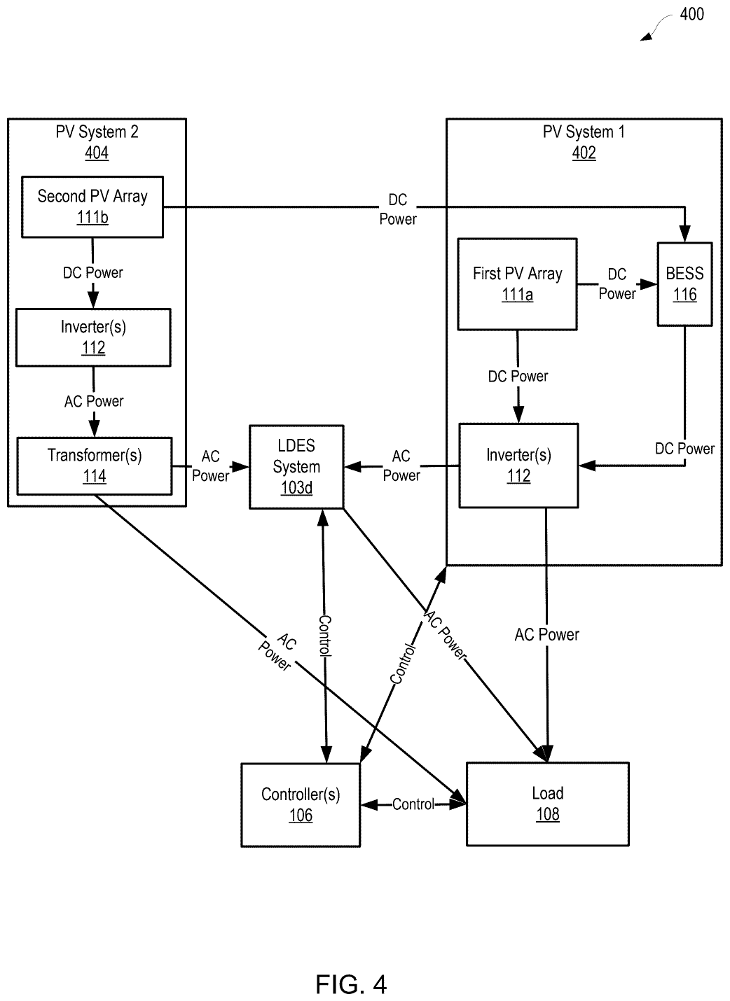

As further explained below, such as shown in FIGS. 3 and 4, in one or some embodiments, the controller 106 may be configured to route at least a part of the first source of energy from the generation source of the first renewable energy source 102a (e.g., the first PV array 111a) and/or from the battery system 103c (e.g., the energy stored in the battery system 103c is routed to the LDES system 103d for operation of the second renewable energy source 102b and/or the load 108).

FIG. 2B depicts a block diagram 200B of a hybrid plant system for implementing the disclosed systems and methods. In one or some embodiments, the hybrid plant system may include a first renewable energy source 102a (e.g., first PV array 111a) that may be configured as an DC coupled system and a second renewable energy source 102b (e.g., a second PV array 111b) that may be configured as an AC coupled system. The first PV array 111a may be coupled with the battery system 103c. Further, the first PV array 111a may include or have associated therewith DC-to-AC converter 119 for transmission of AC power to LDES system 103d. The battery system 103c may include a DC-to-AC and AC-to-DC converter 127 to convert DC power to AC power between the battery system 103c and the LDES system 103d. The second PV array 111b may be directly coupled with the LDES system 103d to provide power directly to the LDES system 103d.

In one or some embodiments, the first PV array 111a, the second PV array 111b, the battery system 103c, the LDES system 103d, and the load 108 may be connected to one or more buses, such as to a DC power bus. In this example, the power inverter may be connected to the DC power bus and converts power between the DC power bus and the LDES system 103d and the load 108.

FIG. 2C depicts a block diagram 200C of a hybrid plant system for implementing the disclosed systems and methods. As shown in FIG. 2C, in one or some embodiments, the second renewable energy system may include a second PV array 111b that is AC coupled. As further described below, the load 108 may include a hydrogen system 109 including one or more electrolyzers 140 and hydrogen compressor(s) and tank(s) 138. The hydrogen system 109 may generate hydrogen via electrolysis, where an electric current is passed through water to separate the hydrogen and oxygen molecules.

In one or some embodiments, as further explained below, as shown in FIG. 6, the hydrogen system 109 may be configured to produce hydrogen (e.g., a third source of energy). The controller 106 may be configured to determine common control and to route energy from any one, any combination, or all of the first PV array 111a, the battery system 103c, the second PV array 111b, or LDES system 103d to the hydrogen system 109 (such as one or both of AC energy or DC energy from any one, any combination, or all of the first PV array 111a, the battery system 103c, the second PV array 111b, or LDES system 103d). Therefore, the hybrid plant system integrates different power/energy generation sources including the first PV array 111a, the battery system 103c, and the second PV array 111b, and LDES system 103d to improve efficiency and to provide power/energy to different systems such as the hydrogen system 109.

In one or some embodiments, the common control comprises throttling upward or downward the operation of the one or more electrolyzers 140 based on a combined energy produced and/or available from any one, any combination, or all of the first PV array 111a, the battery system 103c, the second PV array 111b, or LDES system 103d.

FIG. 2D depicts a block diagram 200D of a hybrid plant system for implementing the disclosed systems and methods. As shown in FIG. 2D, the load 108 may include a data center 120 including computer systems and associated components such as an HVAC system.

FIG. 3 depicts a detailed block diagram 300 of a PV/BESS DC coupled system 302, such as first PV array 111a shown in FIG. 2C and BESS 116. In one or some embodiments, the first PV array 111a may include a PV tracker array having photovoltaic solar cells that capture and transform the sunlight directly to generate the first source of energy (e.g., electricity in DC). The first PV array 111a may further include inverter(s) 112 (e.g., power inverter(s)), which may be configured to convert the electricity produced by the PV tracker array in DC to alternating current AC so it may be used by a load 108 including other systems (e.g., the hydrogen system 109 or the data center 120). FIG. 3 further illustrates transformer(s) 114, which may be configured to transform the AC voltage generated by inverter(s) 112. In one or some embodiments, transformer(s) 114 may be a separate device from inverter(s) 112. Alternatively, transformer(s) 114 may be included within inverter(s) 112.

Even though the first PV array 111a may be used as a renewable energy source, the first PV array 111a may not be capable of producing or storing thermal energy since they use direct sunlight that is converted into DC power.

In one or some embodiments, the first PV array 111a may transmit a status including data indicative of the amount of generated first source of energy to the controller 106. The controller 106 may be configured to, based on a received status from the first PV array 111a, automatically determine whether the generated first source of energy exceeds a threshold energy limit or value (e.g., a predefined threshold energy limit or value that may be a previously defined threshold energy/power limit that may be routed to one or more other devices, such as routed to the battery system 103c, routed to the grid, etc.). Responsive to the controller 106 automatically determining that the generated first source of power does not exceed the first threshold energy value, the controller 106 may route the generated first source of energy from the first PV array 111a to other systems (e.g., the load 108). In one example, the first PV array 111a may route the generated DC power from the PV tracker array (which is one example of a photovoltaic system) to the inverter 112 for conversion to AC power. The inverter 112 may, in turn, route the AC power to one or more loads 108 including other systems (e.g., the hydrogen system 109, the data center 120, and the like).

In one or some embodiments, the typical operation of the inverter 112 may include a grid forming operation. In one embodiment, the inverter 112, such as a photovoltaic inverter, may be coupled with the first PV array 111a or the battery system 103c (which may store DC electricity) to store overproduction of energy or with the LDES system 103d (e.g., the CSP/LDES system), which may produce and operate using AC electricity.

In one or some embodiments, the controller 106 may be configured to automatically control the load 108. As discussed in more detail below, the automatic control, as performed by the controller 106, may comprise one or both of: automatically controlling the routing of the power to one or more parts of the load 108 (e.g., to electrolyzer and/or to hydrogen compressor(s) of the hydrogen system 109, see FIG. 6); or automatically controlling operation of the load 108 itself.

In one or some embodiments, the first PV array 111a and the BESS 116 may be connected to a DC power bus 115. Further, the power inverter 112 may be connected to the DC power bus and converts power between the DC power bus and the load 108.

FIG. 4 depicts a diagram 400 including PV System 1 (402) and PV System 2 (404). PV System 1 (402) may include the first PV array 111a shown in FIG. 1 according to one or some embodiments. As shown in FIG. 4, the battery system 103c (an example of which is shown as BESS 116) may be separate from the first PV array 111a. Alternatively, the battery system 103c may be part of the first PV array 111a. Various components may be included within battery system 103c.

As noted above, the inverter(s) 112 may be configured to convert the electricity produced by the first PV array 111s in DC to AC so that the AC power may be used by other systems. Various types of inverters 112 may be used. In one or some embodiments, the first PV array 111a includes an array of PV trackers and each PV tracker may be coupled with a corresponding inverter 112. Alternatively, the inverter 112 may be integrated with the PV tracker.

In one or some embodiments, responsive to the controller 106 automatically determining that the first PV array 111a exceeds a threshold energy value, the controller 106 may automatically route at least a part of the power generated by the first PV array 111a to the load 108. In particular, the controller 106 may automatically route the excess power generated by the first PV array 111a to any one, any combination, or all of the BESS 116, the load 108 or the LDES system 103d. As one example, as illustrated in FIG. 4, a first portion of DC power is routed, via inverters(s) 112 to convert DC power to AC power, to the load 108, and in which a second portion of DC power is routed to the battery system 103c for storage in the BESS 116. Alternatively or additionally, the controller 106 may automatically route at least part of the stored energy from the battery system 103c to the LDES system 103d and/or to the load 108.

In one or some embodiments, the load 108 may be configured to receive AC power, DC power, or a combination of both. In particular, in one or some embodiments in which the load includes the hydrogen system 109, to the extent that part or all of the hydrogen system 109 operates using DC power, the controller 106 may route DC power from the battery system 103c to the hydrogen system 109 and/or from the first PV array 111a to the hydrogen system 109 to provide power to the electrolyzer of the hydrogen system 109. Alternatively, or in addition, to the extent that part or all of the hydrogen system 109 operates using AC power, the controller 106 may route AC power from the battery system 103c (after conversion to AC power) to the hydrogen system 109 and/or from the second PV array 111b (after conversion to AC power) to the hydrogen system 109 to provide power to the hydrogen system 109.

In some embodiments, the battery system 103c may include one or more Battery Energy Storage Systems (BESS) 116 and one or more Power Control Systems (not shown). The BESS 116, working in combination with the first PV array 111a, may help balance the supply and demand of electricity in the power grid, smoothing out peaks and valleys in demand by providing energy during high demand times or storing excess energy during low demand times. Thus, in one or some embodiments, the BESS 116 may include several components, such as batteries, power conversion systems, control systems, and safety systems. Various types of batteries are contemplated. For example, the batteries used in the BESS 116 may be lithium-ion, lead-acid, or other types of batteries, depending on the application and requirements. The PCS may be configured to convert the DC power stored in the batteries into AC power, which may then be used for a variety of purposes, such as to power homes, businesses, and the electrical grid and/or to power the second renewable energy source 102b, LDES system 103d, and/or the load 108 (under control by the controller 106). In one or some embodiments, the controller 106 may be configured to automatically manage the charging and discharging of the batteries to optimize their performance, while the safety systems may ensure that the batteries are safe to operate and do not pose any risk to the users. In this way, the BESS 116 may supply the power needed to various systems, such as parts of the grid, to the second renewable energy source 102b, the LDES system 103d, and/or the load 108 to maintain reliability, such as in the event of temporary faults.

The BESS 116 may be used for various applications, from residential and commercial storage systems to large-scale grid-connected systems. The benefits of the BESS 116 may include reducing energy costs, increasing energy reliability, providing backup power during power outages, and reducing greenhouse gas emissions by integrating renewable energy sources.

FIG. 5 depicts a diagram 500 including CSP system 104. The CSP system 104 may include a solar field 118, a power tower 122, an LDES system 103d including a thermal storage unit (TSU) 124 (e.g., an example of a thermal storage device that includes a collector tower with tanks and heat exchangers), and a power cycle system 130. The solar field 118 may include a CSP heliostat array 121 which includes reflective surfaces that point the sun's rays to the power tower 122. The power tower 122 (alternatively termed a power trough) may comprise any and all types of solar collectors and may be configured to include a focal point or solar central receiver (SCR). The SCR may include a cylindrical receiver, which sits atop of the power tower 122 and is composed of individual panels where heat is collected to charge a heat transfer medium, such as heat transfer solid and/or a heat transfer fluid (HTF), which may flow in a pattern. Thus, various media are contemplated as a heat transfer medium, including a fluid medium, a solid medium, or a combination thereof. As one example, the heat transfer fluid may include binary molten salts (MS), which may be used to make steam to be used by a turbine 134. For a long duration, the binary molten salts may provide cheaper and more efficient form to store power compared with a large lithium bank that may be needed to store energy in the BESS 116. In particular, the cost of running the CSP system 104 per kWh is about half the cost of running a BESS 116. Therefore, the CSP system 104 provides a cheaper form of storage than the BESS 116.

The TSU 124 may be coupled with the CSP system 104 for storing thermal energy (e.g., heat). As a result, the CSP system 104 and/or LDES system 103d may be used to store energy at times when there is little to no sunlight such as during cloudy days or during nighttime to generate electric power. The CSP system 104 and/or LDES system 103d may provide an indirect method that generates alternating current (AC), which is then easy to distribute, for example, to a power network.

The TSU 124 may include a cold salts storage tank 126 or/and a hot salts storage tank 128 where the HTF is stored in order to be used when desired.

In one or some embodiments, the controller 106 may be configured to automatically route respective energy from one or both of the first PV array 111a or the battery system 103c to the CSP system 104 for operation of the TSU 124. As discussed above, one or more ways are contemplated to convert the DC power generated by one or both of the first PV array 111a or the battery system 103c into energy usable by the CSP system 104.

As one example, the DC power from the first PV array 111a and/or the battery system 103c may be converted into heat and/or steam (e.g., via electrical to heat conversion 135, such as heat exchangers) for use by the TSU 124. In one or some embodiments, the DC power from the first PV array 111a and/or the battery system 103c may be used directly to generate heat and/or steam (e.g., DC power supplied to DC operated heaters). Alternatively, or in addition, the DC power from the first PV array 111a and/or the battery system 103c may be converted into AC power, which in turn is used to generate heat and/or steam (e.g., AC power supplied to AC operated heaters). Molten salts used for the TSU 124 may be in solid state at room temperature and liquid state at the higher operation temperatures. For molten salt, lower and upper temperature thresholds may be taken into account by the controller 106. The upper limit may be determined by the thermal stability, the metallic corrosion rate, and other thermo-physical limitations (e.g., high vapor pressure). Salts may be typically classified by the anions which determine the chemical properties (e.g., nitrates, nitrites, chlorides, carbonates). The lower limit may be defined by the melting temperature, which may vary significantly depending on the anion type and the cation composition. Mixtures of different salts may have lower melting temperatures, compared to single salts, but may exhibit similar thermal stability limits. Hence, salt mixtures may have a larger temperature operation range and a lower risk of freezing compared to single salts. Specifically, the molten salts may freeze if the temperature is not maintained at a certain temperature threshold range (e.g., about 290° C.-560° C. if using a solar salt mixture). Further, the molten salt needs to be flowing and circulating via the tubes/piping of the TSU 124. Otherwise, the salt may solidify and a failure of the CSP system 104 may occur. A heat tracing power 137 may be further included to keep the tubes/piping at a hot temperature (e.g., more than 290° F.) to prevent the salt from solidifying and freezing.

In one or some embodiments, the controller 106 may automatically identify the passing of the temperature threshold range. In particular, the controller 106 may automatically receive data including readings from a temperature sensor and may automatically determine that the temperature of the salts may be reaching or passing the low temperature threshold. Responsive to automatically identifying the passing of the temperature threshold, the controller 106 may automatically route power from the first PV array 111a and/or the battery system 103c to the TSU 124 to keep the salt molten (e.g., via the heat tracing power 137).

The CSP system 104 may further include a power cycle system 130. The power cycle system 130 may include a steam generator system (SGS) 132 which transfers the heat from the MS to steam. The power cycle system 130 may further include a turbine 134 (in some embodiments with wet cooling where the heat from the steam is transformed into electricity).

As discussed above, the power from one or both of the first PV array 111a or the battery system 103c may be used to power different parts of the CSP system 104. As one example, the DC power may be converted into heat and/or steam (e.g., via electrical to heat conversion 135, such as heat exchangers) for use by the steam generator system 132. Alternatively, or in addition, the DC power may be converted via electrical to turbine standby operation 139 for use by the turbine 134 to operate the steam turbine at least in a standby operation mode.

In one or some embodiments, the turbine 134 may require parasitic controls to keep the turbine spinning. The controller 106 may be configured to control one or both of the first PV array 111a or the battery system 103c to supply energy (e.g., to route at least part of the first source of energy from one or both of the first PV array 111a or the battery system 103c, to the CSP system 104 for continuous parasitic load operation of the turbine 134 and for typical standby power consumption operation). Various control of operations by the controller are contemplated. For example, turbine normal operation facilitates turbine spinning at high speeds under mechanical load from generator. During standby, there is no generator load; rather, the turbine may be spun to maintain ‘standby’ operation and keep equipment momentum. In this regard, the turbine/generator may have an inherent need in its proper operation. To meet such need under various circumstances, AC power, generated from the PV system and/or battery system, may be utilized, as discussed above.

In one or some embodiments, the generated AC electrical power may be distributed on a power network. The CSP system 104 and/or LDES system 103d may be built on a large scale and may be used to power utilities or provide energy to remote areas. Therefore, the CSP system 104 and/or LDES system 103d may be configured to provide a clean and renewable alternative to fossil fuel-based energy sources.

In one or some embodiments, responsive to the controller 106 automatically determining that the generated second source of power exceeds a second threshold energy value or limit (e.g., a maximum amount of energy that the steam turbine is configured to process), the controller 106 may be configured to automatically route at least part of the generated second source of power that does not exceed the threshold energy value to the turbine 134 and an excess amount of the second source of energy from the CSP system 104 to the battery system 103c for storage. For example, in the case of a high DNI set of days/weeks/time, in which the thermal storage TES is completely charged, and the PV is providing all the electrolyzer needs, excess CSP power may be generated to charge batteries or may be provided or routed back to the grid (optionally, ending if grid tie is available). If batteries are charged and grid tie is unavailable, the heliostats (or other reflectors) may be directed away from the collector to open space to throttle down heating and prevent overheating damage.

In one or more embodiments, the electrolyzer 140 may need water for the electrolysis process. The electrolyzer 140 may be configured to have a water temperature requirement and a flow rate requirement depending on how much power the electrolyzer 140 is consuming. The controller 106 may be configured to automatically determine the amount of water that a condensing unit of the turbine 134 needs for cooling. The controller 106 may be configured to automatically route the hot water stream that comes after cooling the condenser of the turbine 134 and automatically mix it with the inlet water to the electrolyzer 140 in lieu of pouring the hot water back into a pool.

In particular, the controller 106 may be configured to automatically communicate with any one, any combination, or all of the first PV array 111a, the battery system 103c, the CSP system 104, the LDES system 103d, a water supply 136, and the turbine 134. As such, the controller 106 may be configured to automatically control the water supply 136 to automatically supply water to the turbine 134. The controller 106 may further be configured to automatically receive a status from any one, any combination, or all of the first PV array 111a, the battery system 103c, the CSP system 104, the LDES system 103d, the water supply 136, or the turbine 134. The controller 106 may be configured to determine automatic control of any one, any combination, or all of the first PV array 111a, the battery system 103c, the CSP system 104, the LDES system 103d, the water supply 136, or the turbine 134 in order to modify operation of one or more remaining of the first PV array 111a, the battery system 103c, the CSP system 104, the LDES system 103d, the water supply 136, or the turbine 134. In this regard, the controller 106 may be configured to perform the automatic control of any one, any combination, or all of the first PV array 111a, the battery system 103c, the CSP system 104, the LDES system 103d, the water supply 136, or the turbine 134.

In one or some embodiments, the controller 106 may be configured to automatically control the CSP system 104 to control the automatic supply of an amount of heated water and/or steam from the turbine 134 to the hydrogen system 109, and/or to automatically control the water supply 136 to supply water to the CSP system 104 based on the amount of heated water supplied by the turbine 134. In particular, zero waste water or less waste water may be achieved, since the wastewater from the turbine 134 may be automatically reused and automatically routed to the electrolyzer 140 of the hydrogen system 109 for hydrogen production. In one or some embodiments, various design details to the CSP system 104 plant cooling method and wastewater usage to the electrolyzer 140 may be tailored to the applications discussed herein. By way of example, liquid cooling efficiency for CSP systems may be substantially higher than dry cooling efficiency, but may require water for condenser cooling. In one or some embodiments, to achieve zero water waste, but still attain wet cooling efficiency, the hot water may then be automatically redirected to the electrolyzer water inlet and combined with the cold water such that the mixed water combination does not exceed temperature thresholds. In this regard, the system may include one or both of the piping to redirect the water (e.g., to route the hot water to the electrolyzer water inlet) and the controller 106 may be programmed to route the water (e.g., automatically). Thus, water (used to cool a turbine and in the form of heated liquid and/or steam), instead of releasing the steam into the air, may be routed to a part of the load, such as routed to the inlet of the electrolyzer(s) in the hydrogen system, for efficient use in the electrolyzer(s) process therein. Further, in one or some embodiments, the controller 106 may be programmed with the flow rate throttling as part of the automatic control.

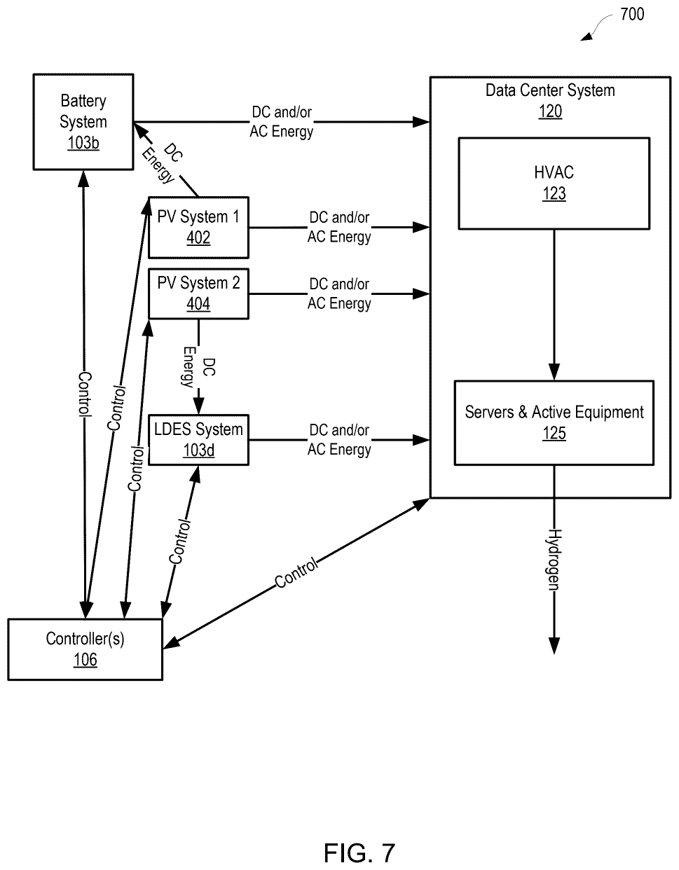

In one or some embodiments, as shown in FIG. 7, instead of or in addition to the hydrogen system, the load 108 may include a data center 120.

FIG. 6 depicts a diagram 600 of the green hydrogen system 109 shown in FIG. 2C, according to one or some embodiments. In one or some embodiments, the hydrogen system 109 which may include the electrolyzer 140 and hydrogen compressor(s) and tank(s) 138 may be configured to generate hydrogen via electrolysis, where an electric current may be passed through water to separate the hydrogen and oxygen molecules. This reaction may occur in the electrolyzer 140. The resulting hydrogen gas may be considered “green” because it is produced without emitting greenhouse gases, unlike the traditional method of hydrogen production from fossil fuels, which may release significant amounts of carbon dioxide into the atmosphere.

In one or some embodiments, the electrolyzer 140 may include a polymer electrolyte membrane (PEM) electrolyzer. The electrolyte may include a solid specialty plastic material. In other embodiments, the electrolyzer 140 may include an alkaline electrolyzer which operates via transport of hydroxide ions (OH—) through the electrolyte from the cathode to the anode with hydrogen being generated on the cathode side. In one or some embodiments, the electrolyzer 140 may include a solid oxide electrolyzer, which uses a solid ceramic material as the electrolyte that selectively conducts negatively charged oxygen ions (O2—) at elevated temperatures, to generate hydrogen in a slightly different way.

In one or some embodiments, the controller 106 may be configured to automatically receive a status from the hydrogen system 109 and based thereon, automatically route a respective energy from one or more of the first PV array 111a or the battery system 103c, or from the CSP system 104 to the hydrogen system 109.

In particular, the controller 106 is configured to automatically route at least a part of the first source of energy from one or more of the first PV array 111a or the battery system 103c, or at least a part of the second source of energy from the CSP system 104 and/or LDES system 103d to the hydrogen system 109, which is configured to produce a third source of energy. For example, the energy routed from any one, any combination, or all of the first PV array 11a, the battery system 103c, the CSP system 104, or LDES system 103d may comprise AC and/or DC power and may be routed to power one or both of electrolyzer 140 or hydrogen compressors and tanks 138.

In one or some embodiments, the controller 106 may be configured to automatically determine, based on the received status, that the first source of energy of the first PV array 111a includes a first portion that does not exceed a threshold energy value (e.g., a maximum amount of energy that the hydrogen system 109 is configured to process), and a second portion which includes an excess amount of energy that exceeds the threshold energy value. The controller 106 may be configured to automatically control the first PV array 111a to route the first portion from the first PV array 111a to the hydrogen system 109 and to automatically control the first PV array 111a to route the second portion from the first PV array 111a to one or both of the battery system 103c for storage or to the CSP system 104 for continuous parasitic load operation.

In one or some embodiments, the hybrid plant system may include the first PV array 111a for daytime energy production and for compensation of parasitic loads of the CSP system 104. The parasitic loads of the CSP system 104 refer to auxiliary energy requirements and losses associated with the operation of the renewable energy systems such as the CSP system 104. The first PV array 111a may improve the efficiency of the hybrid plant system by improving or optimizing the parasitic load of the CSP system 104, reducing the parasitic load consumption of the CSP system 104, and providing a cheaper source of parasitic load feeding plant for the CSP system 104. Thus, in one or some embodiments, the power from the PV system may be routed for various purposes. For example, the power from the first PV array 111a may be used for the CSP system 104 auxiliary systems, such as heat tracing (e.g., to maintain salt temp in lines/tubes), pumps, valves, heliostat (or other reflector) positioning, turbine standby, etc. In one or some embodiments, depending on plant design, it may be more advantageous to use the power from the first PV array 111a for the CSP system 104 parasitics, and to store some or all of the heat energy while keeping the turbine in the CSP system 104 on standby.

In one or more embodiments, the controller 106 may be configured to automatically determine, based on the received status from the hydrogen system 109, that the hydrogen system 109 needs an amount of auxiliary energy to operate. The controller 106 may be configured to automatically control the first PV array 111a to automatically retrieve and automatically supply the amount of auxiliary energy from the respective energy stored in the battery system 103c to the hydrogen system 109.

In one or more embodiments, the controller 106 may be configured to automatically determine that the CSP system 104 may need a first amount of auxiliary energy to operate, automatically determine that the hydrogen system 109 needs a second amount of auxiliary energy to operate, and automatically retrieve and automatically supply the first amount of auxiliary energy from the energy stored in the battery system 103c to the CSP system 104 and/or LDES system 103d and/or the second amount of auxiliary power stored in the battery system 103c to the hydrogen system 109 based on a priority condition and an auxiliary energy availability condition.

In one or some embodiments, the controller 106 may be configured to automatically control the first PV array 111a to generate a level of the first source of power, wherein the level of the first source of power varies based on a first parameter; and control a power cycle output of the CSP system 104 based on the first parameter. In one embodiment, the first parameter may include a time parameter and a weather condition parameter.

In one or some embodiments, as shown in the block diagram 700 in FIG. 7, instead of or in addition to the hydrogen system, the load 108 may include a data center 120. In one or some embodiments, the controller 106 may be configured to automatically receive a status from the data center 120 and based thereon, automatically route a respective energy from one or more of the first PV array 111a, the battery system 103c, the CSP system 104 and/or LDES system 103d to the data center 120.

In particular, the controller 106 is configured to automatically route at least a part of the first source of energy from one or more of the first PV array 111a or the battery system 103c, or at least a part of the second source of energy from the CSP system 104 and/or LDES system 103d to the data center 120, which is configured to host computer systems and associated components. For example, the energy routed from any one, any combination, or all of the first PV array 111a, the battery system 103c, the CSP system 104, or LDES system 103d may comprise AC and/or DC power and may be routed to power one or both of computer systems and associated components, such as servers and active equipment 125, and HVAC 123.

In one or some embodiments, the controller 106 may be configured to automatically determine, based on the received status, that the first source of energy of the first PV array 111a includes a first portion that does not exceed a threshold energy value (e.g., a maximum amount of energy that the data center 120 is configured to process), and a second portion which includes an excess amount of energy that exceeds the threshold energy value. The controller 106 may be configured to automatically control the first PV array 111a to route the first portion from the first PV array 111a to the data center 120 to automatically control the first PV array 111a to route the second portion from the first PV array 111a to one or both of the battery system 103c for storage or to the CSP system 104 for continuous parasitic load operation.

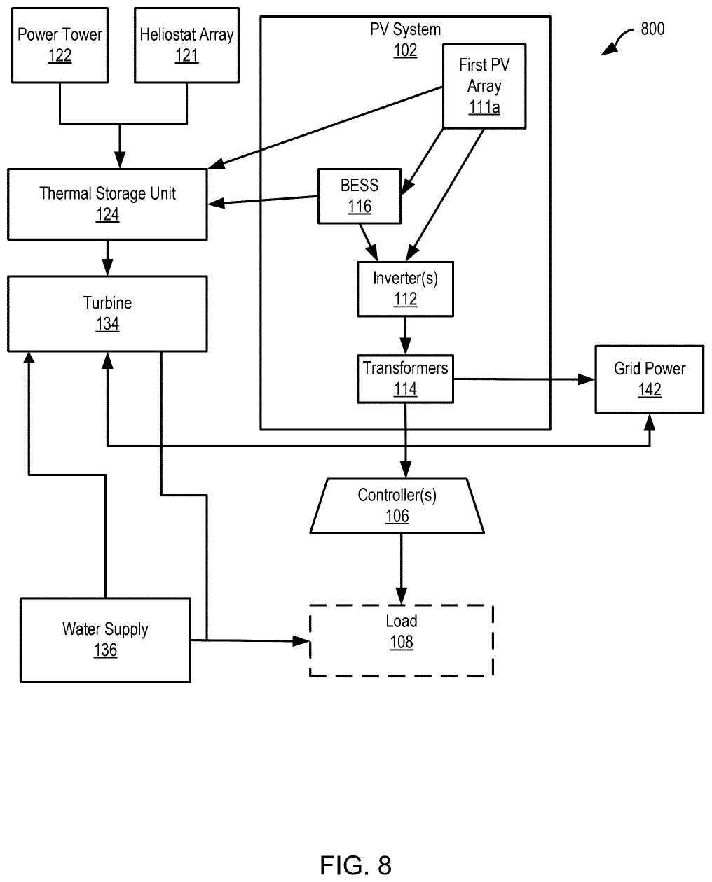

FIG. 8 depicts a schematic layout 800 of the hybrid plant system shown in FIG. 2C, for implementing the disclosed systems and methods. In one or some embodiments, the hybrid plant system includes first PV array 111a, one or more inverters 112 (e.g., a photovoltaic inverter), one or more transformers 114, a power tower 122, a CSP heliostat array 121, and a controller 106 (such as a plant controller).

The first PV array 111a transforms sunlight directly to generate DC energy (e.g., power, electricity). The inverters 112 may convert the DC energy produced by the first PV array 111a to AC energy. In one or some embodiments, the first PV array 111a has its own inverter(s) to create AC power, and the battery system 103c has its own inverter to create AC power. Further, in one or some embodiments, the DC power from the first PV array 111a may be used to charge the battery system 103c via a PCS (power conversion system), with the PCS having inverter(s) included therein.

In one or some embodiments, the hybrid plant system may include a power tower 122 (or any other collector method), a CSP heliostat array 121 (or any other reflector method), tanks (or any other storage method) and TSU 124 (which may comprise one or both of tanks or heat exchangers), a turbine 134, and a water supply 136. The CSP heliostat array 121 includes reflective surfaces that point the sun's rays to the power tower 122. The power tower 122 may be configured to collect thermal energy and charges a heat transfer fluid which includes molten salts used to make steam to be used by the turbine 134. The water supply 136 supplies water to the turbine 134 for cooling purposes. The TSU 124 (which may comprise one or both of tanks and heat exchangers) store and transfer the thermal energy to the turbine 134. The turbine 134 uses the thermal energy and the water to produce steam which is used to generate AC energy to be used by other systems. In one or some embodiments, the heat transfer fluid may be used to heat the water to superheated vapor. In particular, in one or some embodiments, at least two closed-loop circuits may be used, one for the HTF, and a second for the water/steam to spin the turbine. Further, in one or some embodiments, a third unassociated water line may be used to cool the condenser (separate from the at least two closed-loop circuits). In addition, there may be a water inlet to the electrolyzer, which may utilize the hot condenser water (e.g., used for wet cooling).

In one or some embodiments, the hybrid plant system may include a load 108. In one or some embodiments, the load 108 may include a hydrogen system 109 for producing green hydrogen. The hydrogen system 109 may include pumps and electrolyzer 140 and hydrogen compressors and tanks 138.

In one or some embodiments, the hybrid plant system may include a BESS 116, configured to store energy based on various conditions or triggers mentioned above, and PCS 117 configured to convert DC power to AC power. For example, the various conditions may include the amount of energy produced by first PV array 111a, the amount of energy that other systems such as the hydrogen system 109 may use, and the like. In one or some embodiments, the BESS 116 may be configured to store energy based on control by the controller 106 as mentioned above. In one or some embodiments, the controller 106 controls the inverters 112 to route the energy to the BESS 116 based on the status of the first PV array 111a, the inverters 112, TSU 124, the turbine 134, or the hydrogen system 109.

In one or some embodiments, the transformers 114 may receive the AC energy and convert the level of AC energy including a voltage and a current into another level of AC energy including another voltage and current to be used by other systems. In particular, the transformers 114 may receive the AC energy from the inverters 112 as an input at a first level of voltage and current. The transformers 114 may output a second level of voltage and current that may be used by other systems (e.g., a grid power 142), the hydrogen system 109, or the turbine 134. As shown, the connection between turbine 134 and grid power 142 is bidirectional to indicate that grid power 142 may be used to power the turbine 134 and/or the turbine 134 may have its excess power routed (and sold) to the grid power 142. Alternatively, or in addition, power may be routed from one or both of transformers 114 or PCS to grid power 142, as shown in FIG. 7.

In one or some embodiments, the controller 106 may receive a status from the TSU 124 or the turbine 134 and may control routing of respective energy from one or both of the first PV array 111a or the BESS 116 to the TSU 124. As discussed above, one or more ways are contemplated to convert the DC power generated by one or both of the first PV array 111a or the BESS 116 into energy usable by the TSU 124 or the turbine 134. As one example, the DC power may be converted into heat and/or steam (e.g., via electrical to heat conversion 135, such heat exchangers) for use by the hot salts storage tank 128. As another example, the DC power may be converted into heat and/or steam (e.g., via electrical to heat conversion 135, such heat exchangers) for use by the turbine 134. Moreover, in one or some embodiments, the turbine 134 is configured to perform power conditioning (such as via one or more transformers) in order to AC power at a designated power output.

In one or some embodiments, the controller 106 may be configured to automatically receive a status from the hydrogen system 109 and based thereon, automatically route a respective energy from one or more of the transformers 114 or the BESS 116, or from the turbine 134 to the hydrogen system 109.

In one or some embodiments, the controller 106 may be configured to automatically receive a status from the hydrogen system 109 and based thereon, automatically route water from the water supply 136 or from the turbine 134.

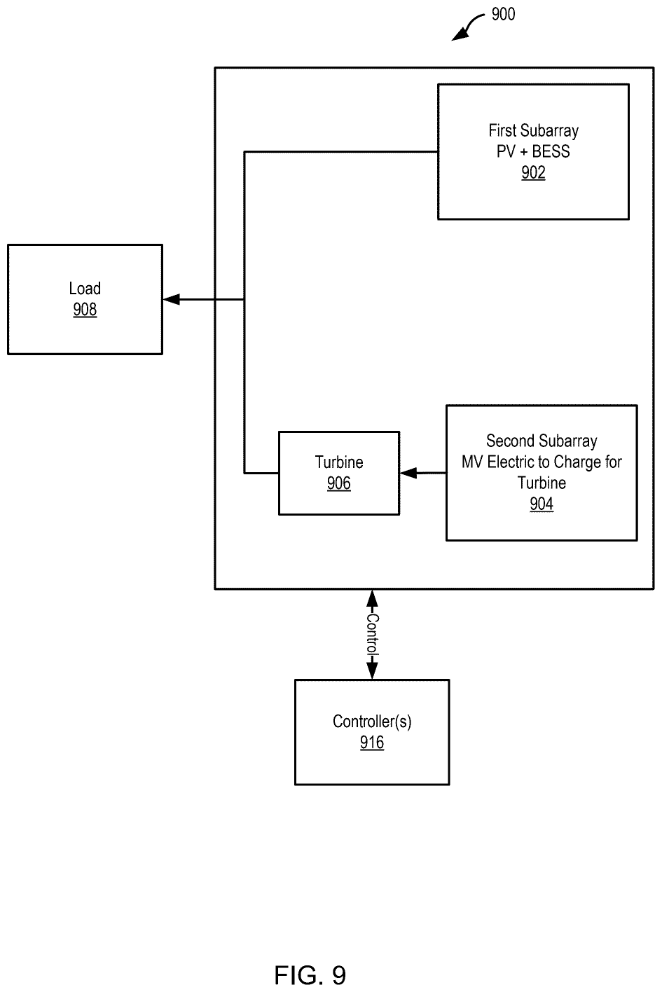

FIG. 9 depicts a schematic layout of a hybrid plant system 900 for implementing the disclosed systems and methods. In one or some embodiments, the hybrid plant system 900 includes a first subarray 902 (e.g., a daytime renewable array), a second subarray 904 (e.g., a nighttime renewable array), turbine systems 906, a load 908, and a controller 916. The first subarray 902 may include a PV and a BESS. The second subarray 904 may include MV electric to charge the turbine. In one or some embodiments of the hybrid plant system 900, the power output of the plant array design should be consistent during the daytime and nighttime.

The controller 916 may control the supply of power and storage by turning on and off the supply of energy from the first subarray 902 or the second subarray 904 based on real time conditions and historical conditions including daytime/nighttime and seasonal conditions, sun irradiation (direct normal irradiation index (DNI) and a status based on the power production and energy storage of the first subarray 902 and the second subarray 904.

In one or some embodiments, the first subarray 902 may supply energy during the daytime (e.g., from 6:00 am to 6:00 pm) and the second subarray 904 may supply energy during the night (e.g., from 6:00 pm to 6:00 am).

In one or some embodiments, the second subarray 904 may include a PV inverter 112 and a shared medium voltage transformer 114. Therefore, no high voltage transformer, no substation, and no interconnection is necessary.

In one or some embodiments, the hybrid plant system 900 may utilize turbine waste heat during the summer to supply energy to a data center 120 for base load air conditioners and adsorption chillers and during the winter for base load air conditioners. In other words, the hybrid plant system 900 provides curtailed power to seasonal and/or auxiliary thermal storage.

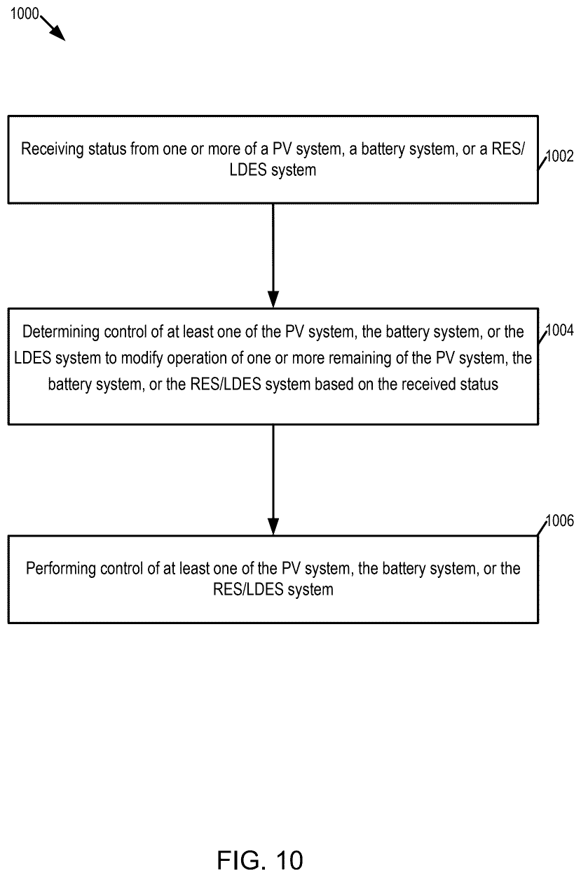

FIG. 10 depicts a flow diagram 1000 for controlling the hybrid plant system shown in FIG. 5, according to one or some embodiments. At block 1002, a status is automatically received, by the controller 106, from one or more of a first PV array 111a, a battery system 103c, CSP system 104 and/or LDES system 103d.

At block 1004, control of any one, any combination, or all of the first PV array 111a, the battery system 103c, the CSP system 104, or LDES system 103d is automatically determined, by the controller 106, in order to automatically modify operation of one or more remaining of the first PV array 111a, the battery system 103c, the CSP system 104 and/or LDES system 103d based on the received status.

At block 1006, the control of any one, any combination, or all of the first PV array 111a, the battery system 103c, the CSP system 104 and/or LDES system 103d is automatically performed, by the controller 106.

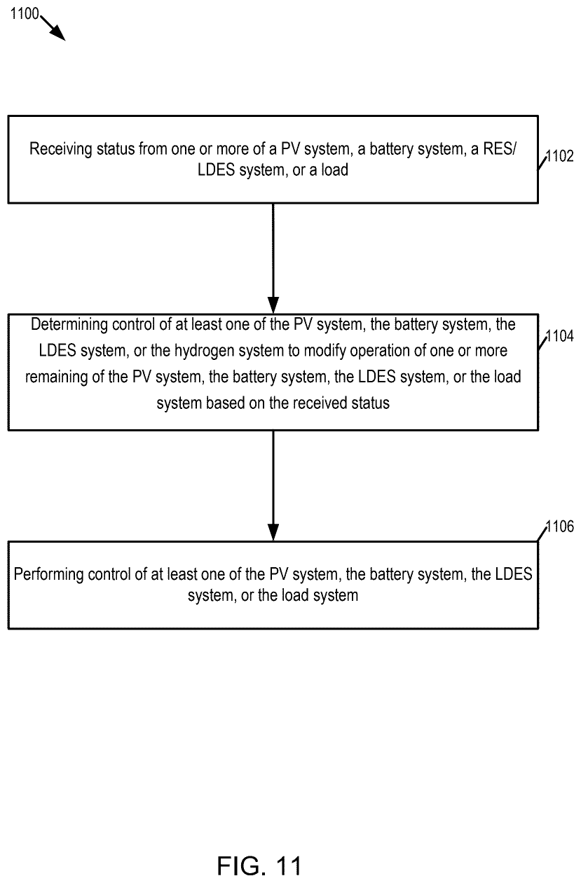

FIG. 11 depicts a flow diagram 1100 for controlling the hybrid plant system shown in FIG. 2A, according to one or some embodiments. At block 1102, a status is received, by the controller 106, from one or more of a first PV array 111a, a battery system 103c, a CSP system 104, or LDES system 103d, or a load 108.

At block 1104, an automatic control of any one, any combination, or all of the first PV array 111a, the battery system 103c, the CSP system 104, the LDES system 103d, or the load 108 is determined, by the controller 106, in order to automatically modify operation of one or more remaining of the first PV array 111a, the battery system 103c, the CSP system 104, the LDES system 103d, or the load 108 based on the received status.

At block 1106, the control of any one, any combination, or all of the first PV array 111a, the battery system 103c, the CSP system 104, LDES system 103d, or the load is automatically performed, by the controller 106.

In one or some embodiments, the CSP system 104 and/or LDES system 103d may provide nighttime production to the hybrid plant system depicted in flow diagram 1100 by means of the TSU 124 which grants the ability to dispatch the energy when necessary. Combining the CSP system 104 and/or LDES system 103d with other storage methods may provide an off-grid (no transmission connection) for loads such as green hydrogen systems 109 and data centers 120.

One of the goals of the disclosed systems and methods is to keep the CSP system 104, the LDES system 103d, the first PV array 111a, and the load 108 running without being connected to a power grid (off-grid microgrid).

As noted above, external factors or transients that may affect the operation of the CSP system 104 may include weather events such as cloud coverage and temperature. In particular, in some embodiments, the CSP system 104 may have a need for high levels of irradiance.

In one or some embodiments, the disclosed CSP system 104 with storage for thermal energy offers a solution as it makes it possible to store solar energy and feed electricity to the grid at short notice to complement the production flows of renewable variables. In one example, the production of the first PV array 111a may fall at the end of the afternoon and the CSP system 104 with thermal energy storage releases the stored energy to meet the demand. In one embodiment, when photovoltaic production of the first PV array 111a reaches its highest point, the CSP system 104 may stop feeding electricity to the systems such as the grid and store the energy as heat, which may be used when needed, even at night.

In one or some embodiments, integration of the CSP system 104, the LDES system 103d, the first PV array 111a, and the load 108 may be determined by different energy needs and requirements. The controller 106 may be configured to switch from the CSP system 104 to first PV array 11a, based on a determination of a load configuration that complies with the energy requirements of the load 108. In particular, the sizing of the CSP system 104 and/or LDES system 103d may be correctly configured and optimized based on its production hours by adjusting the load for each month according to its monthly storage capacity.

In one or some embodiments, the controller 106 is configured to control the CSP system 104 to charge energy in the TSU 124 during the day, while the first PV array 111a is producing electricity and store the energy to produce it during nighttime so the consumption from other systems such as the grid may be minimized. The controller 106 is configured to control the first PV array 111a to power the electrolyzer 140 during the day, along with the CSP system 104 parasitic loads (e.g., turbine, pumps, and the like.). In particular, the power tower 122 charges/injects the salt with heat during the day and discharges at night for routine operation.

In one or some embodiments, the controller 106 is configured to control the first PV array 111a to output a maximum load it may provide each moment since its main target is daytime production. The controller 106 may control the CSP system 104 to optimize energy production within its production hours by adjusting the load for any season according to its seasonally adjusted storage capacity. In one or some embodiments, the different loads at which the electrolyzer 140 may work are 100%, 75%, and a minimum load of 50% (or less, depending on the technology) of the total capacity. Thus, throttling of power from any one, any combination, or all of the CSP system 104, the first PV array 111a, or the battery system 103c to the electrolyzer may vary dynamically, such as based on seasonal impacts (e.g., less in colder weather, such as winter, versus more in warmer weather, such as summer). Further, power requirements of different electrolyzers may vary; thus, the controller 106 may be configured to determine the power needs of a respective electrolyzer, and to supply power from any one, any combination, or all of the CSP system 104, the first PV array 111a, or the battery system 103c to tailor the power needs to the respective electrolyzer.

In one or some embodiments, the controller 106 may be automatically configured to control the CSP system 104 and to automatically adjust the load based on the monthly available energy (solar radiation). In particular, the controller 106 may be configured to automatically determine the DNI for each month and set the power cycle output. In one example, for the months with low accumulated DNI, the controller 106 may set the power cycle system 130 output to 50%. For the months with average accumulated DNI, the power cycle system 130 output may be set to 75% by the controller 106. For the months with high accumulated DNI, the power cycle system 130 output may be set to 100% by the controller 106.

In one or some embodiments, the controller 106 may be configured to automatically determine when the output (e.g., the first source of energy) of the first PV array 111a is not available and may automatically activate the CSP system 104 to take over.

In one or some embodiments, any one, any combination, or all of the electrolyzer 140, hydrogen compressors and tanks 138 and throttle of the equipment may be automatically controlled based on solar production requirements. Transients and seasonal weather events may require different scheduled operation. Other manual controls may be needed for safety override, preemptive weather events (storm, water loss, etc.), and the like.

In an example where solar clipping occurs (e.g., when the first PV array 111a produces more power than what the inverter 112 is configured to process), the first PV array 111a may route part or all of the excess power to the LDES system 103d for storage. In one embodiment, the CSP system 104 and/or LDES system 103d may be overprovisioned. This may require whatever CSP system 104 equipment is powered by the clipped DC to be able to use that high voltage, which may be performed on heaters, heat tracing, etc. In one or some embodiments, overprovisioning may comprise the first PV array 111a being purposely overbuilt for the specific case of using DC power directly from the array to power the CSP system 104 parasitics and/or to direct the excess power to the BESS 116 for charging.

In one or some embodiments, the controller 106 is configured to automatically obtain 70 percent utilization (or some other median value, depending on electrolyzer design) with the combination of the first PV array 111a and the CSP system 104. In one or some embodiments, the controller 106 is configured to oversize one of the renewable systems including the first PV array 111a, the CSP system 104 and to control both systems to clip the extra power to the battery system 103c for storage. In one or some embodiments, the system may be purposely oversized for the purposes mentioned above.

In one or more embodiments, when the CSP system 104 may not be used when the first PV array 111a is operating, the turbine 134 would be in stand-by mode, particularly during the day when the CSP system 104 is not providing power to the turbine 134. This may not be beneficial since it adds wear-and-tear to the turbine. Therefore, the controller 106 may be configured to automatically control the CSP system 104 to keep the turbine 134 powered constantly (24 hours a day/7 a week) by using curtailed energy from any one, any combination, or all of the first PV array 111a, the battery system 103c, the hydrogen system 109, or grid power. Therefore, the life of the turbine 134 may be extended by eliminating off time.

In one or some embodiments, as mentioned above, electrical heaters (resident in the first PV array 111a or the CSP system 104) may be configured to transfer energy (in the form of DC power) from the first PV array 111a to heat or steam for use by the turbine 134.

In one or more embodiments, the BESS 116 may be used for auxiliary power and also to power turbine heaters and/or for the HTF.

In one or more embodiments, the controller 106 may automatically control the hydrogen system 109 to route excess hydrogen to the CSP system 104 for operation of the turbine 134.

In one or more embodiments, the controller 106 may be configured to automatically determine a priority on how the loads (e.g., the different sources of energy) are used for any one, any combination, or all of the electrolyzer 140, the BESS 116, and the turbine 134. The controller 106 may automatically define or determine a threshold energy value to control the electrolyzer 140 to always be on and to automatically control the turbine 134 not to be on standby.

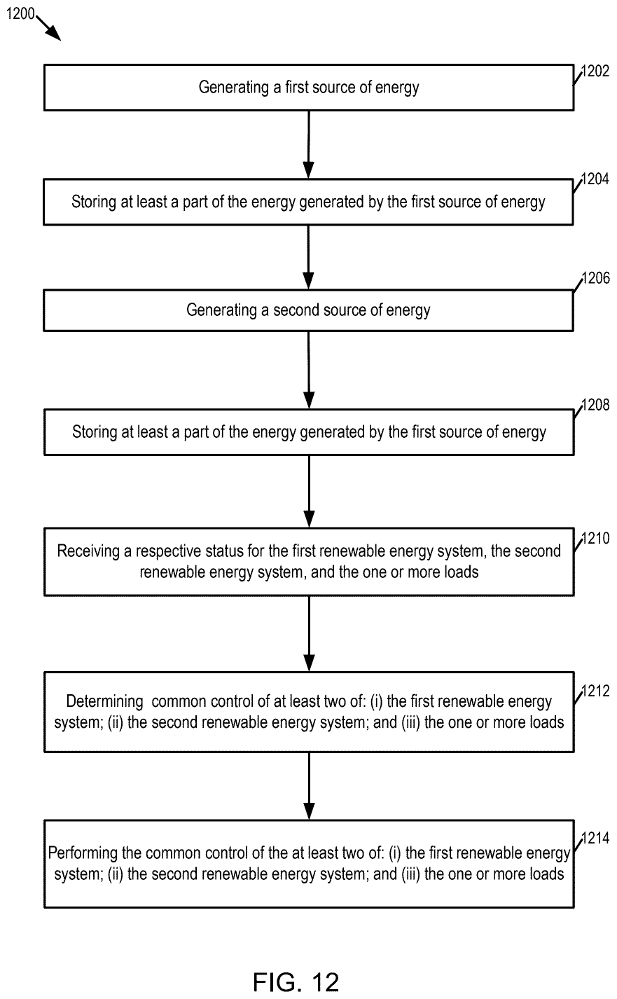

FIG. 12 depicts a flow diagram 1200 for operation of the hybrid plant system shown in FIG. 5, according to one or some embodiments. In one or some embodiments, the operation of the hybrid plant system may include: generating, by a first renewable energy system, a first source of energy (1202); storing, by the first renewable energy system, at least a part of the energy generated by the first source of energy (1204); generating, by a second renewable energy system, a second source of energy (1206); storing, by the second renewable energy system, at least a part of the energy generated by the second source of energy, wherein the second source of energy is of a different type than the first source of energy (1208); receiving, by at least one controller in communication with the first renewable energy system, the second renewable energy system, and one or more loads, a respective status for the first renewable energy system, the second renewable energy system, and the one or more loads, wherein the respective status of the first renewable energy system is indicative of stored energy or forecasted generated energy of the first renewable energy system, wherein the respective status of the second renewable energy system is indicative of the stored energy or the forecasted generated energy of the second renewable energy system, and wherein the respective status of the one or more loads is indicative of operation of the one or more loads (1210); determining, by the at least one controller, common control of at least two of: (i) the first renewable energy system; (ii) the second renewable energy system; and (iii) the one or more loads (1212); and performing, by the at least one controller, the common control of the at least two of: (i) the first renewable energy system; (ii) the second renewable energy system; and (iii) the one or more loads (1214).

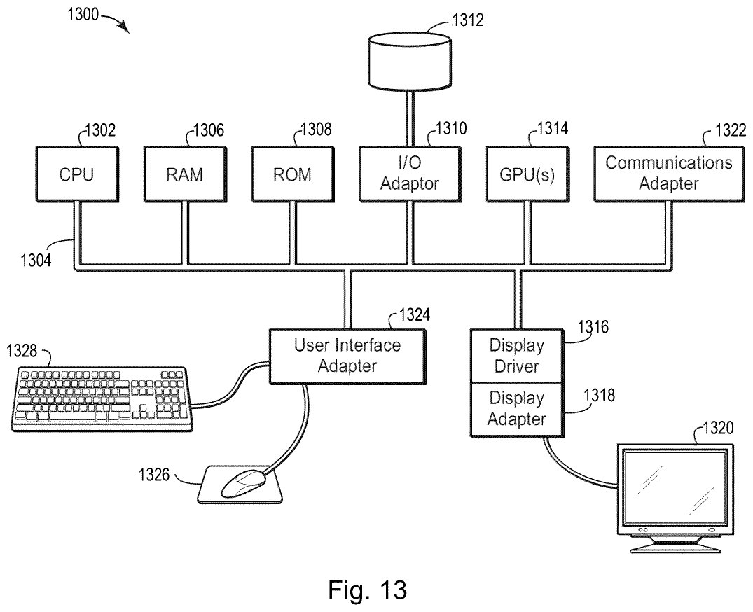

FIG. 13 is a diagram of an exemplary computer system 1300 that may be utilized to implement the systems and methods, including the flow diagrams, described herein. A central processing unit (CPU) 1302 is coupled to system bus 1304. The CPU 1302 may be any general-purpose CPU, although other types of architectures of CPU 1302 (or other components of exemplary computer system 1300) may be used as long as CPU 1302 (and other components of computer system 1300) supports the operations as described herein. Those of ordinary skill in the art will appreciate that, while only a single CPU 1302 is shown in FIG. 13, additional CPUs may be present. Moreover, the computer system 1300 may comprise a networked, multi-processor computer system that may include a hybrid parallel CPU/GPU system. The CPU 1302 may execute the various logical instructions according to various teachings disclosed herein. For example, the CPU 1302 may execute machine-level instructions for performing processing according to the operational flow described herein.

The computer system may also include computer components such as non-transitory, computer-readable media. Examples of computer-readable media include computer-readable non-transitory storage media, such as a random-access memory (RAM) 1306, which may be SRAM, DRAM, SDRAM, or the like. The computer system may also include additional non-transitory, computer-readable storage media such as a read-only memory (ROM) 1308, which may be PROM, EPROM, EEPROM, or the like. RAM 1306 and ROM 1308 hold user and system data and programs, as is known in the art. In this regard, computer-readable media may comprise executable instructions to perform any one, any combination, or all of the blocks in the flow charts in FIGS. 10-12. The computer system may also include an input/output (I/O) adapter 1310, a graphics processing unit (GPU) 1314, a communications adapter 1322 (e.g., a communication interface), a user interface adapter 1324, a display driver 1316, and a display adapter 1318.

The I/O adapter 1310 may connect additional non-transitory, computer-readable media such as storage device(s) 1312, including, for example, a hard drive, a compact disc (CD) drive, a floppy disk drive, a tape drive, and the like to computer system. The storage device(s) may be used when RAM 1306 is insufficient for the memory requirements associated with storing data for operations of the present techniques. The data storage of the computer system may be used for storing information and/or other data used or generated as disclosed herein. For example, storage device(s) 1312 may be used to store configuration information or additional plug-ins in accordance with the present techniques. Further, the user interface adapter 1324 couples user input devices, such as a keyboard 1328, a pointing device 1326 and/or output devices to the computer system. The display adapter 1318 is driven by the CPU 1302 to control the display on a display device 1320 to, for example, present information to the user such as images generated according to methods described herein.

The architecture of the computer system may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system may include various plug-ins and library files. Input data may additionally include configuration information.

It is intended that the foregoing detailed description be understood as an illustration of selected forms that the invention may take and not as a definition of the invention. It is only the following claims, including all equivalents, which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting models discussed herein may be downloaded or saved to computer storage.

What is claimed is:

1. A hybrid plant system comprising:
a first renewable energy system configured to generate a first source of energy and to store at least a part of the energy generated by the first source of energy;
a second renewable energy system configured to generate a second source of energy and to store at least a part of the energy generated by the second source of energy, wherein the second source of energy is of a different type than the first source of energy;
at least one controller in communication with the first renewable energy system, the second renewable energy system, and one or more loads, and configured to:
receive a respective status for the first renewable energy system, the second renewable energy system, and the one or more loads, wherein the respective status of the first renewable energy system is indicative of stored energy or forecasted generated energy of the first renewable energy system, wherein the respective status of the second renewable energy system is indicative of the stored energy or the forecasted generated energy of the second renewable energy system, and wherein the respective status of the one or more loads is indicative of operation of the one or more loads;
determine common control of at least two of: (i) the first renewable energy system; (ii) the second renewable energy system; and (iii) the one or more loads; and
perform the common control of the at least two of: (i) the first renewable energy system; (ii) the second renewable energy system; and (iii) the one or more loads.

2. The hybrid plant system of claim 1, wherein the common control comprises: routing the energy from one of the first renewable energy system or the second renewable energy system to another of the first renewable energy system or the second renewable energy system.

3. The hybrid plant system of claim 2, wherein the respective status of the first renewable energy system comprises the forecasted generated energy of the first renewable energy system; and
wherein the common control comprises routing the energy from the second renewable energy system to the first renewable energy system based on the forecasted generated energy of the first renewable energy system.

4. The hybrid plant system of claim 3, wherein the forecasted generated energy comprises one of a daily forecast, a weekly forecast, or a seasonal forecast.

5. The hybrid plant system of claim 1, wherein the first renewable energy system comprises a shorter-term energy storage system;
wherein the second renewable energy system comprises a longer-term energy storage system; and
wherein the common control is indicative of routing the energy between the shorter-term energy storage system and the longer-term energy storage system.

6. The hybrid plant system of claim 5, wherein the common control for routing the energy between the shorter-term energy storage system and the longer-term energy storage system is based on one or both of the forecasted generated energy of the first renewable energy system or the forecasted generated energy of the second renewable energy system.

7. The hybrid plant system of claim 5, wherein the common control for routing the energy between the shorter-term energy storage system and the longer-term energy storage system is based on real-time generated energy of the first renewable energy system or real-time generated energy of the second renewable energy system.

8. The hybrid plant system of claim 1, wherein the common control comprises:
controlling operation of the one or more loads based on combined energy of the first renewable energy system and the second renewable energy system.

9. The hybrid plant system of claim 8, wherein the one or more loads comprises a hydrogen system including one or more electrolyzers; and
wherein the common control comprises throttling upward or downward the operation of the one or more electrolyzers based on a combined energy of the first renewable energy system and the second renewable energy system.

10. The hybrid plant system of claim 8, wherein the one or more loads comprises a data center including computer systems and associated components.

11. The hybrid plant system of claim 1, wherein at least one of the first renewable energy system or the second renewable energy system include at least one byproduct; and
wherein the common control comprises routing the at least one byproduct from the at least one of the first renewable energy system or the second renewable energy system for use by the one or more loads.

12. The hybrid plant system of claim 11, wherein the at least one byproduct comprises at least one of steam or heated water; and
wherein the at least one controller is further configured to control routing of the steam or the heated water for use by the one or more loads.

13. The hybrid plant system of claim 1, wherein the first renewable energy system comprises a first photovoltaic array; and
wherein the second renewable energy system comprises a second photovoltaic array, at least one turbine, and at least one thermal storage device.

14. A method for managing a hybrid plant system, the method comprising:
generating, by a first renewable energy system, a first source of energy;
storing, by the first renewable energy system, at least a part of the energy generated by the first source of energy;
generating, by a second renewable energy system, a second source of energy;
storing, by the second renewable energy system, at least a part of the energy generated by the second source of energy, wherein the second source of energy is of a different type than the first source of energy;
receiving, by at least one controller in communication with the first renewable energy system, the second renewable energy system, and one or more loads, a respective status for the first renewable energy system, the second renewable energy system, and the one or more loads, wherein the respective status of the first renewable energy system is indicative of stored energy or forecasted generated energy of the first renewable energy system, wherein the respective status of the second renewable energy system is indicative of the stored energy or the forecasted generated energy of the second renewable energy system, and wherein the respective status of the one or more loads is indicative of operation of the one or more loads;
determining, by the at least one controller, common control of at least two of: (i) the first renewable energy system; (ii) the second renewable energy system; and (iii) the one or more loads; and
performing, by the at least one controller, the common control of the at least two of: (i) the first renewable energy system; (ii) the second renewable energy system; and (iii) the one or more loads.

15. The method of claim 14, further comprising:
routing, by the at least one controller, the energy from one of the first renewable energy system or the second renewable energy system to another of the first renewable energy system or the second renewable energy system.

16. The method of claim 15, wherein the respective status of the first renewable energy system comprises the forecasted generated energy of the first renewable energy system; and
further comprising routing, by the at least one controller, the energy from the second renewable energy system to the first renewable energy system based on the forecasted generated energy of the first renewable energy system.

17. The method of claim 14, wherein the first renewable energy system comprises a shorter-term energy storage system;
wherein the second renewable energy system comprises a longer-term energy storage system; and
wherein the common control is indicative of routing the energy between the shorter-term energy storage system and the longer-term energy storage system.

18. The method of claim 17, wherein the common control for routing the energy between the shorter-term energy storage system and the longer-term energy storage system is based on one or both of the forecasted generated energy of the first renewable energy system or the forecasted generated energy of the second renewable energy system.

19. The method of claim 14, further comprising:
controlling, by the at least one controller, operation of the one or more loads based on combined energy of the first renewable energy system and the second renewable energy system;
wherein the one or more loads comprises a hydrogen system including one or more electrolyzers; and
further comprising throttling, by the at least one controller, upward or downward the operation of the one or more electrolyzers based on a combined energy of the first renewable energy system and the second renewable energy system.

20. The method of claim 14, wherein at least one of the first renewable energy system or the second renewable energy system include at least one byproduct, the method further comprising:
routing, by the at least one controller, the at least one byproduct from the at least one of the first renewable energy system or the second renewable energy system for use by the one or more loads.

21. The method of claim 20, wherein the at least one byproduct comprises at least one of steam or heated water; and
wherein the method further comprises: routing, by the at least one controller, the steam or the heated water for use by the one or more loads.

22. A hybrid plant system comprising:
a photovoltaic (PV) system configured to directly convert solar irradiation to generate a first source of energy;
a battery system configured to store at least a part of the first source of energy;
a concentrated solar power (CSP) system configured to concentrate solar energy to generate a second source of energy;
a long-duration energy storage (LDES) system configured to store at least a part of the second source of energy; and
at least one controller in communication with the PV system, the battery system, the LDES system and the CSP system, and configured to:
receive a respective status from one or more of the PV system, the battery system, the LDES system or the CSP system;
determine control of one or more of: the PV system or the battery system; LDES system or the CSP system in order to modify operation of one or more remaining of: the PV system or the battery system; or the LDES system or the CSP system based on the respective status; and
perform the control of one or more of: the PV system or the battery system; or the LDES system or the CSP system.
